(19) United States
(12) Patent Application Publication
(10) Pub. No.: US 2023/0088430 A1
(43) Pub. Date: Mar. 23, 2023

(54) MECHANICAL CURRENT CUT-OFF DEVICE FOR HIGH-VOLTAGE DIRECT CURRENT WITH A CAPACITOR IN A SECONDARY PATH, FACILITY AND METHOD USING SUCH A DEVICE

(71) Applicant: SuperGrid Institute, Villeurbanne (FR)

(72) Inventors: Florent MOREL, Bourg-en-Bresse (FR); Paul VINSON, Lyon (FR); Thanh VU CONG, Lyon (FR); Nihal EL FAHIM, Villeurbanne (FR); Alain GIRODET, Chaseieu (FR)

(21) Appl. No.: 17/904,054

(22) PCT Filed: Feb. 12, 2021
(86) PCT No.: PCT/FR2021/050260

§ 371 Date: Aug. 11, 2022

(30) Foreign Application Priority Data
Feb. 13, 2020 (FR) 2001456

(51) Int. Cl. H01H 33/12; H01H 33/16

(52) U.S. Cl. CPC H01H 33/127; H01H 33/167

(57) ABSTRACT

A mechanical cut-off apparatus of a high-voltage electric circuit includes: in a main electrical path a main mechanical switch; in a secondary electrical path, a secondary mechanical switch; a mechanical control configured such that, the secondary mechanical switch is brought to its mechanically open state after the main mechanical switch has been brought to its mechanically open state; the apparatus includes a transition dipole comprising a capacitance, the transition dipole arranged in series with the pair of secondary electrical contacts in the secondary electrical path, and in that the apparatus includes a controlled switch which, in an electrically closed state, creates inside the mechanical cut-off apparatus a bypass that short-circuits the capacitance of the transition dipole.

### TECHNICAL FIELD

The invention relates to the field of networks for the transmission and/or distribution of high-voltage direct current, generally referred to by the acronym HVDC. The invention particularly relates to mechanical current cut-off paparatuses intended for such networks.

HVDC networks are in particular contemplated as a solution for the interconnection of disparate or non-synchronous electricity production sites. The HVDC networks are in particular envisaged for the transmission and distribution of energy produced by offshore wind farms rather than AC technologies, due to lower line losses and to absence of impact of the parasitic capacitances of the network on long distances. Such networks typically have voltage levels on the order of 100 kV and more.

In the present text, for a device in which a direct current circulates, either a “high-voltage A” device in which the nominal operating voltage is greater than 1,500 V in direct current but less than or equal to 75,000 V (75 kV), or a “high voltage B” device when the nominal operating voltage is greater than 75,000 V (75 kV) in direct current, is considered as a high-voltage device. Thus, the field of high DC voltage includes the field of “high-voltage A” and that of “high-voltage B”.

The direct current cut-off in such networks is a crucial issue directly conditioning the feasibility and development of such networks.

The evolution of these networks today tends towards the interconnection of infrastructures to lead to mesh networks, that is to say networks including several possible pathways between two given points in the network. In these networks, there are electrical installations, including in particular electrical stations or electrical substations, in which there is at least one electric circuit cut-off apparatus within an electric circuit.

In an electric circuit, there is generally at least one voltage source, and at least one voltage user, which can comprise any apparatus or set of apparatuses or any network having such apparatuses that use the electrical energy to transform it into another form of energy, for example into mechanical, and/or calorific, and/or electromagnetic energy, etc.

In an electric circuit, there is generally at least one electric circuit cut-off apparatus for interrupting the circulation of the electric current in the circuit, generally between the voltage source and the voltage user, or between the voltage source and the ground.

Different types of electric circuit cut-off apparatuses are known. For example, circuit breakers are known, which are mechanical cut-off apparatuses of the electric circuit and which are designed and dimensioned to authorize in particular a charge or fault mode opening of the electric circuit in which they are interposed. However, the circuit breakers are complex, expensive and bulky apparatuses, and they are intended for network protection functions. Electric circuit cut-off apparatuses, of simpler design are further known, such as disconnectors which are generally not designed to cut off circuits in charge, but rather to ensure, in a circuit where the circulation of current is already interrupted by another cut-off apparatus, the safety of property and people during interventions, by ensuring electrical insulation of a predetermined high level between an upstream portion of the circuit, linked for example to the voltage source, and a downstream portion of the circuit.

In a mechanical cut-off apparatus, the current cut-off is obtained only by the opening of a mechanical switch element. Such a mechanical switch element includes two contact-making conductive parts which are in mechanical and electrical contact when the switch element is closed and which mechanically separate when the switch element is open. These mechanical cut-off apparatuses have several drawbacks when they are traversed by high currents.

In the presence of a current and/or a high-voltage, the mechanical separation can result in the establishment of an electric arc between the two conductive parts, due to the high energies accumulated in the network that the apparatus protects. As long as the electric arc remains established through the mechanical separation, the cut-off apparatus does not perform the electrical cut-off since a current continues to circulate through the apparatus due to the presence of the arc. The electrical cut-off, in the sense of the effective interruption of the circulation of the electric current, is sometimes particularly difficult to achieve in a context of direct current and high voltage, these conditions tending to maintain the electric arc. Furthermore, this electric arc degrades, on the one hand, by erosion, the two contact-making conductive parts, and on the other hand, by ionization, the environment surrounding the conductive parts in which the arc is established. This requires maintenance operations of the cut-off apparatus which are restrictive and costly.

The high-voltage direct currents (HVDC) cut-off is more complex to achieve than the alternating currents (AC) cut-off. Indeed, upon cut-off of an alternating current, we take advantage of a zero crossing of the current to perform the electrical cut-off, which we cannot benefit from with a direct current, in particular HVDC.

Furthermore, it is known to use, in particular, for high-voltage circuits, apparatuses called “metal-cased” apparatuses where the active cut-off members are enclosed in a sealed enclosure, sometimes called tank or a metal casing, filled with an insulating fluid. Such fluid can be a gas, commonly sulfur hexafluoride (SF₆), but liquids or oils are also used. This fluid is chosen for its insulating nature, in particular so as to have a dielectric strength greater than that of dry air at equivalent pressure. The metal-cased apparatuses can in particular be designed in a more compact manner than the apparatuses where the cut-off and the insulation are performed in the air.

A conventional “metal-cased” mechanical disconnector includes for example in particular two electrodes which are held, by insulating supports, in fixed positions remote from the peripheral wall of an enclosure, for example the metal casing, which is at ground potential. These electrodes are electrically linked to each other or electrically separated from each other depending on the position of a movable connection member forming part of one of the electrodes, for example a sliding tube actuated by a control. The tube is generally carried by a main body of one of the electrodes, to which it is permanently electrically linked, and the separation of the tube relative to the opposite electrode is likely to create an electric arc. A disconnector is generally located in an electrical substation. It is connected to the other elements of the substation, for example by connection bars. On each side of the disconnector, other elements of a substation can be found such as a power transformer, an overhead crossing, etc.

A mechanical disconnector traditionally comprises two pairs of electrical contacts. For example, for each pair, one of the contacts is carried by the sliding tube forming part of one of the electrodes and the other contact of the same pair is carried by the electrode which does not include this sliding tube. A pair of main contacts is the pair through which the nominal current passes in the completely closed position of the apparatus. This current flow path, which will be called main electrical path, is a path of least electrical resistance, thus limiting the conduction losses in the steady state. This pair of main contacts is assisted by a second pair called pair of arc contacts or pair of secondary contacts. The two secondary contacts are intended to remain in sharp contact during the separation of the pair of main contacts, so as not to have any arcing phenomenon on the pair of main contacts, which avoids wear of the main contacts. Conversely, the contacts of the pair of secondary contacts separate lastly and the electric arc is established. They must resist this wear. Arrived at a sufficient arc length, and after a sufficient time, the electric arc is interrupted.

The use of such a mechanical disconnector without a specific device to facilitate the cut-off could cover the lowest stresses of the charging current transfer cases, but is unsuitable for circuits with high loop impedances.

Indeed, in this case, the opening can produce electric arcs likely to stretch to significant lengths and this can cause certain problems. An arc that is too long between the connection member and the opposite electrode can degenerate and develop into a short circuit. For example, in a metal-cased disconnector of the type described above, an arc can be established between the powered electrode and the grounded enclosure wall. In a less extreme case, the arc extinction times can be too long and damage the parts constituting it and thus jeopardize the insulation of the system.

Document WO-2019/077269 describes a mechanical cut-off apparatus including two movable electrodes which, for a complete electrical closing position, allow the passage of a nominal electric current through the apparatus according to a main electrical path. The two electrodes form, for an intermediate position, a secondary electrical path through the apparatus, the main electrical path being interrupted. The apparatus includes, in the secondary electrical path, a surge protector in series with the pair of secondary contacts, and a controlled switch capable of switching a current circulating in the secondary electrical path either through the surge protector, or in a short-circuit of the surge protector. In one illustrated embodiment, the controlled switch is an electrically-piloted electronic switch, which requires, for the electronic switch, a control independent of the control of the electrodes. The electronic switch may present a significant additional cost, and the need to provide a pilot circuit for this electronic switch may increase the cost and complexity of the apparatus and its integration into an installation.

The invention aims to propose a cut-off apparatus of simpler design allowing a charge opening while limiting the arc risks.

### DISCLOSURE OF THE INVENTION

The invention relates to a mechanical cut-off apparatus of a high-voltage electric circuit, the mechanical cut-off apparatus including:

an upstream terminal and a downstream terminal which are intended to be electrically linked respectively to an upstream portion and a downstream portion of the electric circuit;

in a main electrical path between the upstream and downstream terminals of the mechanical cut-off apparatus, a main mechanical switch having a pair of main contacts which are movable relative to each other between at least one open position corresponding to a mechanically open state of the main mechanical switch, and at least one closed position corresponding to a mechanically and electrically closed state of the main mechanical switch in which the main contacts establish a nominal electrical connection of the mechanical cut-off apparatus, said nominal electrical connection allowing the passage of a nominal electric current through the mechanical cut-off apparatus;

in a secondary electrical path which is electrically in parallel with the main mechanical switch between the upstream and downstream terminals of the mechanical cut-off apparatus, a secondary mechanical switch, having a pair of secondary contacts which are movable relative to each other between at least one open position, corresponding to a mechanically open state of the secondary mechanical switch, and at least one closed position corresponding to a mechanically and electrically closed state of the secondary mechanical switch;

a mechanical control of the main mechanical switch and of the secondary mechanical switch configured such that, in an electrical opening operation of the mechanical cut-off apparatus, the secondary mechanical switch is brought to its mechanically open state after the main mechanical switch has been brought to its mechanically open state.

The the apparatus includes a transition dipole comprising a capacitance, the transition dipole being electrically arranged in series with the pair of secondary electrical contacts in the secondary electrical path, and the apparatus includes a controlled switch which, in an electrically closed state, creates inside the mechanical cut-off apparatus a bypass that short-circuits the capacitance of the transition dipole.

The apparatus can further have either of the following characteristics, taken alone or in combination.

The transition dipole and the secondary electrical path are preferably devoid of a dedicated inductive component.

The the transition dipole can include a circuit for discharging the capacitance of the transition dipole.

The the transition dipole can include a voltage limiter arranged electrically in parallel with the capacitance in the transition dipole.

The voltage limiter can be designed as a surge protector.

The discharge circuit can include a discharge resistance which is arranged electrically in parallel with the capacitance and electrically in parallel with the voltage limiter of the transition dipole.

The controlled switch can be electrically arranged in parallel with the transition dipole, in the secondary electrical path, between the secondary mechanical switch and a terminal of the mechanical cut-off apparatus.

The controlled switch can be a tertiary mechanical switch having a pair of tertiary contacts which are movable relative to each other between an open position corresponding to a mechanically open state of the tertiary mechanical switch, and a closed position corresponding to a mechanically and electrically closed state of the tertiary mechanical switch.

The controlled switch is an electronic switch.

The controlled switch can be electrically arranged in parallel with the secondary electrical path, and be a tertiary mechanical switch having a pair of tertiary contacts which are movable relative to each other between at least one open position corresponding to a mechanically open state of the tertiary mechanical switch, and at least one closed position corresponding to a mechanically and electrically closed state of the tertiary mechanical switch.

The mechanical cut-off apparatus can be configured such that:

in an opening operation of the mechanical cut-off apparatus, the controlled switch is brought into an electrically open state after the main mechanical switch has been brought into its mechanically open state and before the secondary mechanical switch is brought into its mechanically open state;

in an electrical closing operation of the mechanical cut-off apparatus, the main mechanical switch and the secondary mechanical switch are brought into their mechanically and electrically closed state after the controlled switch has been brought into an electrically closed state.

The mechanical cut-off apparatus can include a mechanical control of the tertiary mechanical switch, and the mechanical control of the main, secondary and tertiary switches can be configured such that:

in an opening operation of the mechanical cut-off apparatus, the tertiary mechanical switch is brought into its mechanically open state after the main mechanical switch has been brought into its mechanically open state and before the secondary mechanical switch is brought into its mechanically open state;

in a closing operation of the mechanical cut-off apparatus, the main mechanical switch and the secondary mechanical switch are brought into their mechanically and electrically closed state after the switch controlled as a tertiary mechanical switch has been brought into its mechanically and electrically closed state.

In a closing operation of the mechanical cut-off apparatus, the secondary mechanical switch can be brought into its state mechanically and electrically closed after the main mechanical switch has been brought to its electrically and mechanically closed state.

In a closing operation of the mechanical cut-off apparatus, the secondary mechanical switch can be brought into its mechanically and electrically closed state before the main mechanical switch has been brought into its electrically and mechanically closed state.

The mechanical cut-off apparatus can include two electrodes:

which are electrically linked respectively to the upstream terminal and to the downstream terminal of the mechanical cut-off apparatus,

which each carry one of the contacts of the pairs of main, secondary and tertiary contacts,

and which are movable relative to each other along a relative opening movement and a relative closing movement, between at least one electrical opening position corresponding to an electrically open state of the mechanical cut-off apparatus and a complete electrical closing position corresponding to an electrically closed state of the mechanical cut-off apparatus in which the electrodes establish, through the pair of main contacts, the nominal electrical connection of the mechanical cut-off apparatus.

In such a case, on each of the two electrodes, the main contact and the tertiary contact have a fixed position on the considered electrode.

In such a case, for a given relative position of the two electrodes in their opening or closing movement, the main contact pair and the tertiary contact pair have a relative spacing between the contacts of the pair that is different, so that, in an opening operation of the mechanical cut-off apparatus to bring it from its closed state to its open state, for an intermediate position or a range of intermediate positions of the electrodes between the electrical opening position and the complete electrical closing position, the main electrical path is interrupted at the level of the pair of main contacts while an electrical path remains closed at the level of the pair of tertiary contacts;

In such a case, one at least of the contacts of the pair of secondary contacts is movable on the electrode which carries it, between an opening configuration adopted during the opening movement and a closing configuration adopted during the closing movement, the opening and closing configurations corresponding to a different relative spacing between the two contacts of the pair of secondary contacts for the same given relative position of the two electrodes, such that:

during the opening movement, the pair of secondary contacts separates after the pairs of main and tertiary contacts;

during the closing movement, the pair of secondary contacts comes into contact after the pair of tertiary contacts.

In one apparatus according to the invention, the relative closing and opening movements of the electrodes and the relative closing and opening movements between the two contacts of the pairs of main and tertiary contacts can be the same and can be translational movements, and the two configurations of the pairs of secondary contacts can correspond to two different relative positions of the two secondary contacts along the direction of translation for the same relative position of the electrodes.

The invention also relates to an electrical installation including at least one mechanical cut-off apparatus having any one of the preceding characteristics.

The invention also relates to an electrical installation, characterized in that it includes a first electric circuit between a first point and a second point, a second electric circuit, electrically in parallel with the first electric circuit between the first point and the second point, and a mechanical cut-off apparatus having any one of the characteristics above in at least one of the circuits for cutting off the electric current in the circuit.

The invention also relates to a method for cutting off a high-voltage electric circuit implementing a mechanical cut-off apparatus having an upstream terminal and a downstream terminal which are intended to be electrically linked respectively to an upstream portion and a downstream portion of the electric circuit, in which:

a main electrical path is mechanically and electrically opened, between the upstream and downstream terminals of the mechanical cut-off apparatus, which allows the passage of a nominal electric current, to switch the current in a secondary electrical path which is electrically in parallel with the main electrical path between the upstream and downstream terminals of the mechanical cut-off apparatus so as to charge a capacitance inserted into the secondary electrical path;

after expiry of a period following the opening of the main electrical path, the secondary electrical path is mechanically and electrically opened.

In such a method, during the opening of the main electrical path, the electric current can be first switched in a tertiary electrical path which is electrically in parallel with the main electrical path between the upstream and downstream terminals of the mechanical cut-off apparatus before switching it to the secondary electrical path.

In such methods, the voltage across the capacitance can be limited by the presence of a voltage limiter electrically in parallel with the capacitance in the secondary electrical path.

### BRIEF DESCRIPTION OF THE DRAWINGS

FIG. 1 is a schematic view of one example of a high-voltage electrical network in which the invention can be implemented.

FIG. 2 represents a wiring diagram of a network in which the invention can be implemented.

FIG. 3A schematically represents a mechanical cut-off apparatus of the “metal-cased” type in an electrically closed state.

FIG. 3B schematically represents the apparatus of FIG. 3A in an intermediate position of a movable connection member.

FIG. 3C schematically represents the apparatus of FIG. 3A in a mechanically open state.

FIG. 4A schematically represents a mechanical cut-off apparatus in a mechanically open state.

FIG. 4B schematically represents the apparatus of FIG. 4A in an intermediate position of a movable connection member, in a closing configuration.

FIG. 4C schematically represents the apparatus of FIG. 4A in another intermediate position of its movable connection member in an opening configuration.

FIG. 5A schematically represents a cut-off apparatus according to a first electrical architecture.

FIG. 5B schematically represents a cut-off apparatus according to a second electrical architecture.

FIG. 6A schematically represents the apparatus of FIG. 5A in an electrically closed state.

FIG. 6B schematically represents the apparatus of FIG. 5A in an intermediate state.

FIG. 6C schematically represents the apparatus of FIG. 5A in another intermediate state.

FIG. 6D schematically represents the apparatus of FIG. 5A in an electrically open state.

FIG. 7 represents graphs which schematically illustrate the variation of different parameters of a circuit during an opening operation of an apparatus according to the invention.

FIG. 8 represents graphs that schematically illustrate the variation of different parameters of a circuit during part of the opening of an apparatus according to the invention.

FIG. 9 represents graphs which schematically illustrate the variation of different parameters of a circuit during another part of the opening of an apparatus according to the invention.

FIG. 10 represents graphs which schematically illustrate the variation of different parameters of a circuit during yet another part of the opening of an apparatus according to the invention.

FIG. 11A schematically represents the apparatus of FIG. 5A in an electrically open state.

FIG. 11B schematically represents the apparatus of FIG. 5A in an intermediate state.

FIG. 11C schematically represents the apparatus of FIG. 5A in another intermediate state.

FIG. 11D schematically represents the apparatus of FIG. 5A in an electrically closed state.

FIG. 12 represents graphs which schematically illustrate the variation of different parameters of a circuit during a closing operation of an apparatus according to the invention.

FIG. 13A schematically represents the apparatus of FIGS. 4A-4C in an electrically and mechanically closed state.

FIG. 13B schematically represents the apparatus of FIGS. 4A-4C in an intermediate state during an opening operation.

FIG. 13C schematically represents the apparatus of FIGS. 4A-4C in another intermediate state during an opening operation.

FIG. 13D schematically represents the apparatus of FIGS. 4A-4C in a mechanically and electrically open state.

FIG. 14A schematically represents the apparatus of FIGS. 4A-4C in an electrically and mechanically open state.

FIG. 14B schematically represents the apparatus of FIGS. 4A-4C in an intermediate state during a closing operation.

FIG. 14C schematically represents the apparatus of FIGS. 4A-4C in another intermediate state during a closing operation.

FIG. 14D schematically represents the apparatus of FIGS. 4A-4C in a mechanically and electrically closed state.

FIG. 15A schematically represents one variant of the apparatus of FIGS. 4A-4C in an electrically and mechanically open state.

FIG. 15B schematically represents the same variant in an intermediate state during a closing operation.

FIG. 15C schematically represents the same variant in another intermediate state during a closing operation.

FIG. 15D schematically represents the apparatus of FIGS. 4A-4C in yet another intermediate state, during an opening operation.

### DESCRIPTION OF THE EMBODIMENTS

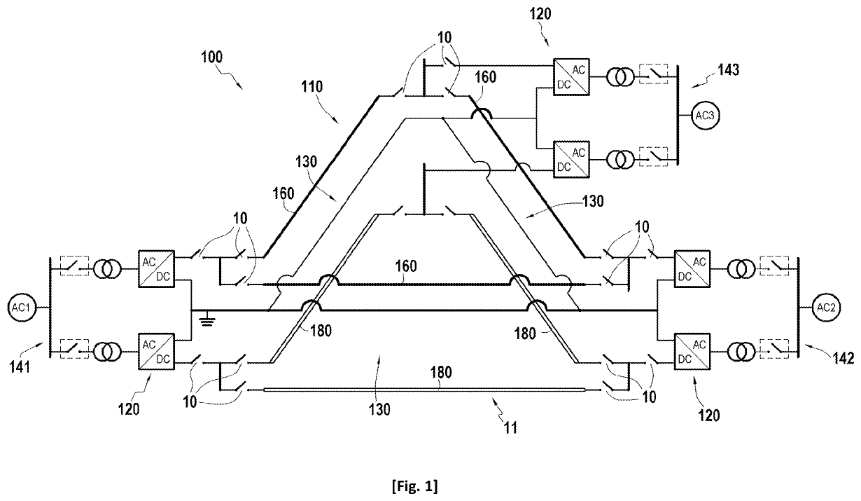

FIG. 1 illustrates a high-voltage electrical network system 100 in which the invention can be implemented. This network system 100 includes a DC high-voltage electrical network portion 110, for example under “high voltage B”, which is linked, by AC/DC converter systems 120, to different AC high-voltage electrical network portions 141, 142, 143, here three in number. In the example illustrated, the DC high-voltage electrical network portion 110 includes three DC high-voltage network sub-portions 130, each of which links a converter system 120 associated with an AC high-voltage network portion 141, 142, 143 with another converter system 120 associated with another AC high-voltage network portion 141, 142, 143. In the example illustrated, the three DC high-voltage network sub-portions 130 therefore link the three AC high-voltage network portions 141, 142, 143 in a triangle configuration.

Each DC high-voltage network sub-portion 130 can for example include in particular a positive-potential DC high-voltage conductor 160 and a negative-potential DC high-voltage conductor 180 and generally a neutral-potential connection, for example a ground neutral-potential connection. In the example illustrated, each DC high-voltage conductor 160, 180 determines a DC high-voltage electric circuit. The DC high-voltage electrical network portion 110 includes, in the DC high-voltage electric circuits defined by the DC high-voltage conductors 160, 180, cut-off apparatuses 10 of an electric circuit each of which can be in an electrically open state in which it interrupts the electric current circulation in the considered electric circuit, or in part thereof, or in an electrically closed state in which it allows the circulation of an electric current in the considered electric circuit. Such a cut-off apparatus 10 is brought from its electrically closed state to its electrically open state by an opening operation, and it is brought from its electrically open state to its electrically closed state by a closing operation.

The cut-off apparatuses 10 of an electric circuit can be in particular of the disconnector type. The cut-off apparatuses of an electric circuit can in particular be mechanical apparatuses, in which the electrical cut-off is obtained by displacement, in particular by spacing, of two electrical contacts or several pairs of electrical contacts. In this case, the displacement of the electrical contacts is generally carried out by a mechanical control which preferably comprises at least one mechanical, pneumatic, hydraulic or electrical actuator, and possibly a transmission between the actuator and the electrical contacts. The transmission has a movement transmission kinematics which transforms a movement of the actuator into a relative movement of the contacts. This displacement can be electronically monitored, for example by an electronic monitoring unit piloting the actuator.

In a DC high-voltage network, for example of the type of the DC high-voltage network portion 110 described above, it may be necessary to conduct maneuvers of charge line current transfer by the disconnectors.

These transfer maneuvers occur to reorient the power flow between network portions while continuing to service all the clients of the network. In the diagram of FIG. 1, representing one example, the network portion 143 generates electrical power which is partly consumed in the network portions 141 and 142. For various reasons, linked for example to flow maintenance or reorganization requirements, the link between the network portions 143 and 142 must be interrupted.

This is done by opening at least one or two of the cut-off apparatuses 10 in the electric circuits linking the network portions 143 and 142. For example, a cut-off apparatus 10 of the DC high-voltage network sub-portion is opened 130 which links the network portions 143 and 142.

The power supplied by the network portion 143 can continue to supply the network portions 141 and 142, but the flows are modified because there is no longer any power transiting directly between the network portions 143 and 142.

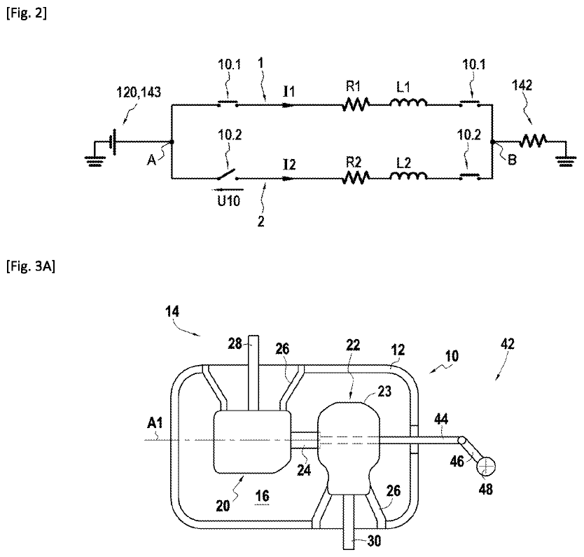

In other words, as illustrated in the equivalent wiring diagram of FIG. 2, during the opening of the direct electric circuit 2 between the network portions 143 and 142, by opening of a disconnector 10.2, a parallel circuit 1 exists so as not to interrupt the power flow and the current transfer maneuver can be carried out, the disconnector(s) 10.1 remaining in an electrical closing state. The parallel circuits 1 and 2 each extend between a junction point A and a junction point B, which are therefore common to the two parallel circuits 1 and 2. Between these two junction points A and B, the parallel circuits 1 and 2 have no electrical link therebetween.

Thanks to the invention, such transfer maneuvers can be carried out by an opening operation of a mechanical cut-off apparatus, in particular of the disconnector type, including when there is no circuit breaker in the electric circuit associated with this mechanical cut-off apparatus.

In the case contemplated within the scope of the invention, because there remains a parallel electric circuit, the voltage U10 across the mechanical cut-off apparatus 10.2, in this case the disconnector 10.2, after the opening operation of the mechanical cut-off apparatus 10.2, is equal to the voltage drop along the parallel circuit 1. This voltage drop is, in DC voltage, essentially equal to R1×I1, with R1 the equivalent resistance of the parallel electric circuit 1 and I1 the value of the electrical intensity in the parallel electric circuit 1 when the current I2 in the direct electric circuit 2 is zero. In an application of a network under “high-voltage B”, this voltage drop along the parallel circuit 1 is for example on the order of 1,000 volts, for example comprised between 500 and 5,000 volts.

In the exemplary embodiment, the mechanical cut-off apparatus 10 is a disconnector. In the example, the mechanical cut-off apparatus is provided to cut off a single electric circuit, but the invention could be implemented in an apparatus provided to cut off several electric circuits, then including, for example within the same enclosure, several cut-off devices in parallel.

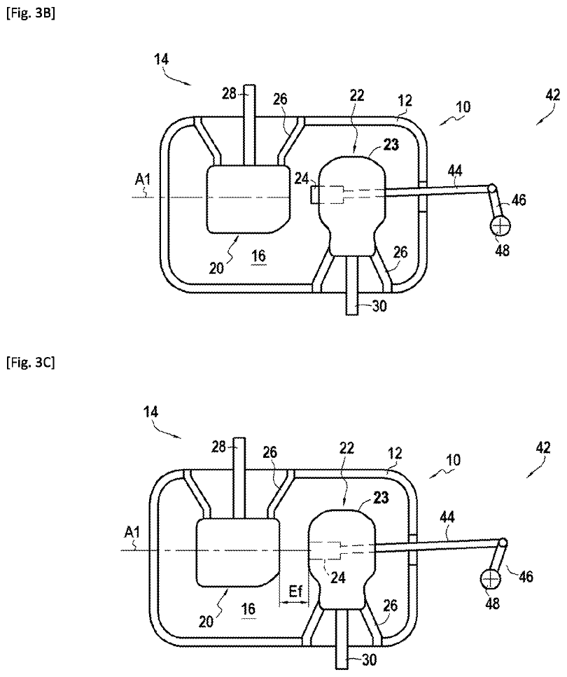

The invention will more particularly be described within the framework of a mechanical cut-off apparatus of the “metal-cased” type. Such an apparatus is schematically illustrated in FIGS. 3A to 3C. However, the apparatus may be an outdoor apparatus.

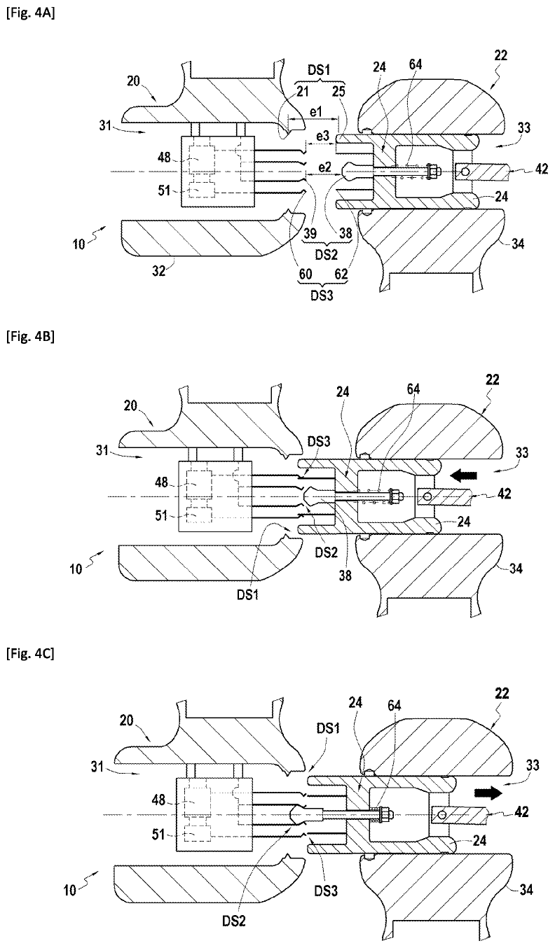

A detail of one particular embodiment is illustrated in more detail, but still schematically, in FIGS. 4A-4C which more particularly show one embodiment of an apparatus having different pairs of contacts which separate or come into contact for different positions of a movable contact of the apparatus.

The mechanical cut-off apparatus 10 thus includes an enclosure 12 which delimits an internal volume 16 of the enclosure 12. Preferably, in operation of the apparatus, the enclosure 12 is sealed relative to the outside of the enclosure 12. The enclosure 12 can include one or several opening(s) (not represented) allowing, at least for maintenance or mounting operations, the access to the internal volume 16 from outside the enclosure, or allowing the volume 16 to be put into communication with another volume of another enclosure adjoined to the enclosure 12 around the opening. The openings are therefore intended to be obturated, for example by portholes or covers, or are intended to put the internal volume 16 of the enclosure 12 into communication with another enclosure itself sealed, by sealed correspondence of the opening with a corresponding opening of the other enclosure. Thanks to this sealing, the internal volume 16 of the enclosure 12 can be filled with an insulating fluid which can be separated from the atmospheric air. The fluid can be a gas or a liquid. The pressure of the fluid can be different from the atmospheric pressure, for example a pressure greater than 3 bars absolute, or can be a very low pressure, typically less than 1 millibar, possibly close to vacuum. The vacuum would be, within the meaning of the invention, assimilated to an insulating fluid. The insulating fluid can be air, in particular dry air, preferably at a pressure greater than the atmospheric pressure, in particular greater than 3 bars absolute. However, preferably, the fluid is chosen for its high insulating properties, for example by having a dielectric strength greater than that of dry air under equivalent temperature and pressure conditions. Thus, the fluid can be sulfur hexafluoride (SF₆), under a pressure greater than 3 bar absolute.

In some embodiments, including the embodiment illustrated in FIGS. 3A-3C and FIGS. 4A-4C, the mechanical cut-off apparatus 10 includes at least two electrodes which are intended to be electrically linked respectively to an upstream portion and a downstream portion of the electric circuit to be cut off. The two electrodes are movable relative to each other along an opening movement and a closing movement, between at least one relative complete electrical closing position, illustrated in FIG. 3A, in which they establish a nominal electrical connection of the apparatus, and therefore corresponding to an electrically closed state of the mechanical cut-off apparatus, and a relative electrical opening position, illustrated in FIG. 3C and corresponding to an electrically open state of the mechanical cut-off apparatus. In the example illustrated, the mechanical cut-off apparatus 10 includes in particular a first fixed electrode 20 and a second electrode 22 which includes a fixed main body 23 and a movable connection member 24. It is understood that the movable connection member could form part of the first electrode 20, or that each of the two electrodes 20, 22 could comprise a movable connection member.

In the example illustrated, each electrode 20, 22 is fixed in the enclosure 12 via an insulating support 26. Outside the enclosure 12, the mechanical cut-off apparatus 10 includes, for each electrode, a connecting terminal 28, 30 which is electrically linked to the corresponding electrode 20, 22. One of the terminals is intended to be linked to an upstream portion of the electric circuit while the other of the terminals is intended to be linked to a downstream portion of the electric circuit. Arbitrarily, and without this having any particular meaning as to the polarity or direction of the current circulation, the upstream portion of the electric circuit will be referred to as the portion which is linked to the first electrode 20, by the connecting terminal 28, which can therefore be referred to as upstream terminal. Consequently, the downstream portion of the electric circuit is the portion which is linked to the second electrode 22, by the connecting terminal 30, which can therefore be referred to as downstream terminal.

In the example, each electrode 20, 22 is permanently electrically linked to the associated connecting terminal 28, 30, regardless of the open or closed state of the mechanical cut-off apparatus.

As indicated above, the mechanical cut-off apparatus 10 is intended to be included in an electrical installation 100 comprising a DC high-voltage electric circuit 2, one example of which is illustrated in FIG. 1 by either of the DC high-voltage conductors 160, 180. In such an installation, it can then be considered that the first electrode 20 is electrically linked to an upstream portion of the electric circuit comprising a voltage source 120 which can be a main source, such as a voltage generator, or a secondary source such as a converter. In the upstream portion of the DC high-voltage electric circuit 2, in particular between the voltage source 120 and the mechanical cut-off apparatus 10, all kinds of electrical apparatuses can be found. Similarly, in the downstream portion of the DC high-voltage electric circuit 2, all kinds of electrical apparatuses can be found.

The main bodies of the two electrodes 20, 22 are disposed in the internal volume 16 in a fixed manner, spaced from the peripheral wall of the enclosure 12, and spaced from each other in such a way that an inter-electrode electrical insulation space is arranged along the direction of a central axis Al, between the portions facing their respective outer peripheral surfaces.

In the example illustrated, the movable connection member 24 of the second electrode of the mechanical cut-off apparatus can include a sliding tube, of axis Al, which is slidably guided along the central axis A1, which will be arbitrarily referred to as longitudinal, in the second electrode 22. In the example illustrated, the movable connection member 24 is preferably made of conductive material, for example metal. In the example illustrated, the movable connection member 24 is electrically linked to the main body 23 of the second electrode 22, therefore electrically linked with the associated connecting terminal 30 permanently, whatever the position of the movable connection member 24.

The connection member 24 is movable along an opening movement relative to the opposite electrode 20, between a relative complete electrical closing position, visible in FIG. 3A, and in which the electrical connection member 24 establishes a nominal electrical connection with said opposite electrode 20 through a pair of main contacts each carried by one of the electrodes, and a relative electrical opening position, visible in FIG. 3C, passing through intermediate relative positions such as the one illustrated in FIG. 3B. In a known manner, the connection member 24 can be moved by a mechanical control 42. In this exemplary embodiment, the mechanical control 42 includes, as a transmission, a connecting rod 44 which is movable along a direction substantially parallel to the axis A1, which is controlled by a rotary lever 46, and which monitors the displacement of the movable connection member along the axis A1 between the electrical opening position and the complete closing position. This mechanical control can comprise at least one mechanical, pneumatic, hydraulic or electrical actuator, for example acting directly or indirectly on the rotary lever 46. The transmission, here comprising the connecting rod 44 and the lever 46, has a movement transmission kinematics which transforms a movement of the actuator into a relative movement of the contacts. An electronic monitoring unit can be provided to pilot the potential actuator.

To reach its relative complete electrical closing position, the connection member 24 is moved longitudinally along the central axis A1 in the direction of the first electrode 20, across the inter-electrode electrical insulation space. In the remainder of the text, it is considered that the relative complete electrical closing position is the position of last electrical contact between the two electrodes through a pair of main contacts, one of which is carried by each electrode, in the direction of the opening of the mechanical cut-off apparatus. For this relative complete electrical closing position, a circulation of electric current is possible by conduction through a mechanical contact between the respective main contacts of the two electrodes. In some apparatuses, there may be a dead travel between an extreme electrical closing position and the last electrical contact position between the two electrodes, in the direction of the opening of the mechanical cut-off apparatus. On this dead travel, an electric current circulation is possible by conduction through a mechanical contact between the respective main contacts of the two electrodes.

In the example illustrated, in the complete electrical closing position of FIG. 3A, the movable connection member 24 is in direct contact with the body of the first electrode 20 by mechanical contact between a main contact 21 (illustrated in FIGS. 4A-4C) carried by the body of the first electrode 20, and a main contact 25 (illustrated in FIGS. 4A-4C) of the movable connection member 24 which, in the particular embodiment illustrated in FIGS. 4A-4C, is a cylindrical portion of the front end 25 of the sliding tube 36. In this electrically closed state of the mechanical cut-off apparatus 10, the nominal electric current, or at least a large part of it, circulates along a main electrical path 2P, which is direct, in this case directly between the movable connection member 24 and the main body of the first electrode 20, through the pair of main contacts 21, 25. The movable connection member 24 therefore forms, with the body of the first electrode, at the level of the pair of main contacts 21, 25, a main mechanical switch DS1.

In general, the main mechanical switch DS1 is electrically interposed in the main electrical path 2P without any other electrical switch, without a dedicated inductive component in the main electrical path between the two terminals 28, 30 of the mechanical cut-off apparatus 10. Any parasitic inductance or impedance in the main electrical path 2P will be of course reduced to the smallest possible value.

In this embodiment of the invention, the two electrodes 20, 22, 24 include a pair of secondary contacts 38, 39 which form, by their contact, for a range of intermediate positions of the electrodes between the electrical opening position and the complete electrical closing position, a secondary electrical path for the electric current through the mechanical cut-off apparatus.

In the particular embodiment illustrated in FIGS. 4A-4C, the first electrode 20 includes a secondary contact formed by a contactor 39 which is intended to be in contact with the connection member 24 when the mechanical cut-off apparatus is in an intermediate closing state, in this example more particularly with a secondary contact of the connection member 24, designed as a contactor 38. On the contrary, when the connection member 24 has reached an opening position, as illustrated in FIG. 4A, the electrical contact between the secondary contact 38 of the movable connection member 24 and the secondary contact 39 of the first electrode 20 is broken.

In the example, the secondary contact 39 of the first electrode 20 is electrically linked to the body 21 of the first electrode, therefore to the upstream portion of the electric circuit 2. The secondary contact 38 of the second electrode 22 is electrically linked to the movable member 24, and therefore to the downstream portion of the electric circuit 2.

In the example, the secondary contact 39 of the first electrode 20 is fixed and extends along a tubular geometry of axis A1, so as to delimit an open inner bore along the axis A1. In the example, it can be designed as several conductive contact blades, which extend each in a radial plane containing the axis A1, disposed about the axis A1 following this tubular geometry, and all including a free contact end at the same radial distance from the axis A1. The secondary contact 38 of the second electrode 22, here carried by the movable connection member 24 and permanently electrically linked thereto, is configured, for all the positions of the range of relative intermediate positions of the electrodes for which the secondary electrical path is formed, to be engaged in the inner bore of the contactor 39 of the first electrode 20, ensuring electrical contact between the two secondary contacts. This is illustrated in FIG. 4C. In the example, the secondary contact 38 of the second electrode is designed as a contact rod of axis A1 carried at the free end of the movable member 24. In the electrically closed position of the secondary mechanical switch DS2, the free contact end of each of the conductive contact blades forming the secondary contact 39 bears on an outer surface of the secondary contact 38 in the form of a contact rod. On the contrary, beyond the electrical opening position, the contact between the two secondary contacts 38, 39 is lost. The movable connection member 24 therefore forms, with the body of the first electrode, at the level of the pair of secondary contacts 38, 39, a secondary mechanical switch DS2.

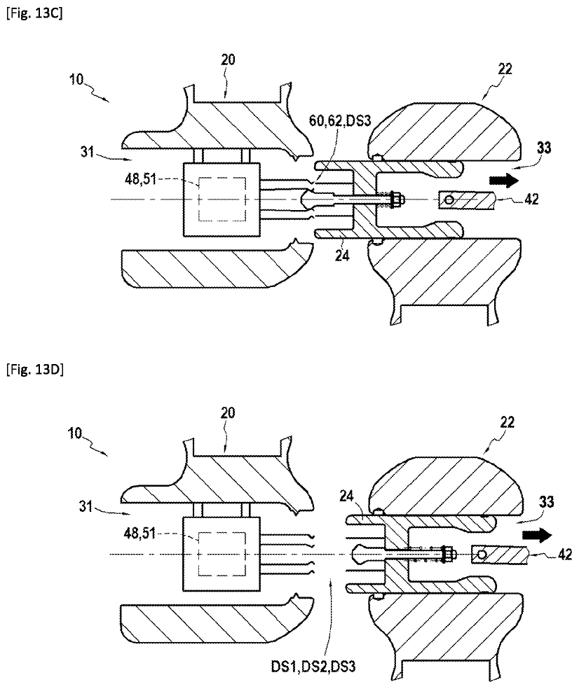

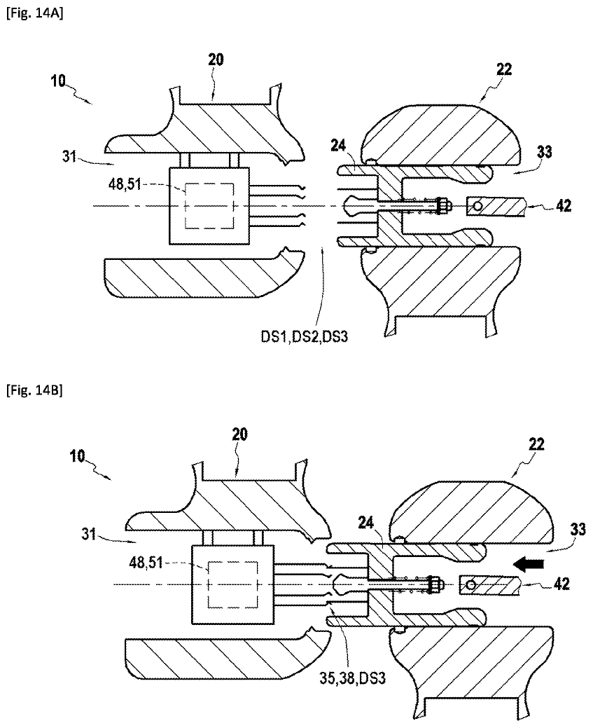

In the example illustrated, the secondary contact 38 of the second electrode is advantageously movable on the electrode which carries it, between an opening configuration of the mechanical cut-off apparatus 10 which is adopted during the opening movement (FIG. 4C) a closing configuration of the mechanical cut-off apparatus 10 which is adopted during the closing movement (FIG. 4B). In the example of FIGS. 4A-4C, also illustrated in FIGS. 13A-13D et14A-14D, it is therefore in particular the secondary mechanical switch DS2 that has two different configurations relative to the electrodes to modify the configuration of the mechanical cut-off apparatus 10. These two configurations of the secondary mechanical switch DS2, and consequently of the mechanical cut-off apparatus 10, allow obtaining a first contact of the two secondary contacts during the closing and a last contact of the two secondary contacts 38, 39 during the opening which correspond to different relative positions of two electrodes, more particularly, in this embodiment, at different relative positions of the movable connection member 24 relative to the first electrode 20. However, it could be provided that the opening configuration and the closing configuration of the mechanical cut-off apparatus 10 correspond to two different configurations of the controlled switch DS3 and/or of the main mechanical switch DS1, in addition to or instead of the existence of two different configurations of the secondary mechanical switch DS2.

The pairs of main 21, 25 and secondary 38, 39 contacts are designed and disposed so that, for a range of intermediate positions of the electrodes for which the secondary contacts are in contact with each other, the main contacts are spaced from each other to interrupt the main electrical path. In the example illustrated, for a relative opening position of the electrodes, the spacing “e1” between the two main contacts 21, 25 is greater than the spacing “e2” between the two secondary contacts 38, 39, in any case during an opening operation.

In the example illustrated, each of the pairs of main and secondary contacts includes a first contact 21, 39 carried by the first 20 of the two electrodes and a second contact 25, 38 carried by the second 22 of the two electrodes, in this case by its movable member 24. Thus, each of the pairs of main and secondary contacts has a relative closing movement and a relative opening movement between the two contacts which is the same as the relative opening and closing movements of the two electrodes 20, 22.

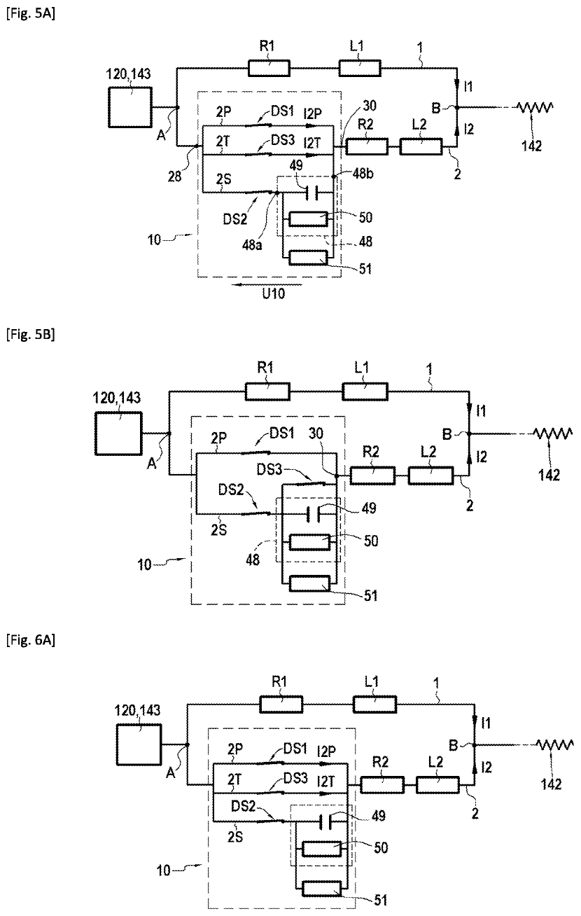

FIG. 5A illustrates, in the form of a wiring diagram, a first electrical architecture of a mechanical cut-off apparatus 10 according to the invention, inserted into an electric circuit 2, within a simplified network similar to the one illustrated in FIG. 2. FIG. 5B illustrates a second electrical architecture, which differs from the first electrical architecture only by the different disposition of a controlled switch which, in an electrically closed state, creates inside the mechanical cut-off apparatus a bypass that short-circuits the capacitance 49 of a transition dipole 48, as will be described below. For the rest, the two electrical architectures are identical.

In these two diagrams, the pair of main contacts 21, 25 is represented as a switch DS1 inserted into the main electrical path 2P inside the mechanical cut-off apparatus 10. The pair of secondary contacts 38, 39 is represented as a switch DS2 inserted into the secondary electrical path 2S inside the mechanical cut-off apparatus 10. As represented, the main electrical path 2P and the secondary electrical path 2S are parallel electrical paths between the two terminals 28, 30 of the mechanical cut-off apparatus 10.

In the invention, the relative movements of the pair of main contacts 21, 25 and the pair of secondary contacts 38, 39 are temporally coordinated during an opening or closing operation of the mechanical cut-off apparatus. In the preferred embodiment, this time coordination is obtained by a mechanical link through which, for each of the two electrodes 20, 22, 24, the main contact and the secondary contact are secured to each other following a geometry which can take two configurations, a first configuration being implemented during opening operations and movements, and the other configuration being implemented during closing operations and movements. The time coordination thus corresponds, for the opening operations and movements, to a first time offset between the respective opening of the two pairs of contacts, and, for the closing operations and movements, to a second time offset between the respective closing of the two pairs of contacts, the second time offset being of different duration from the first time offset, the time offsets resulting from the different relative deviations between the contacts of the two pairs.

As can be seen in FIGS. 5A and 5B, the mechanical cut-off apparatus 10 includes a transition dipole 48 comprising a capacitance 49, the transition dipole 48 being electrically arranged in series with the pair of secondary electrical contacts 38, 39 in the secondary electrical path 2S. In addition, the apparatus includes a controlled switch DS3 which, in an electrically closed state, creates inside the mechanical cut-off apparatus a bypass that short-circuits the capacitance 49 of the transition dipole 48.

The capacitance 49 of the transition dipole 48 includes at least one dedicated capacitive component. A dedicated capacitive component is typically a capacitor. A capacitor includes two conductive plates (sometimes called “electrodes”) in total influence and separated by an insulator. One of the conductive plates of the capacitor is therefore linked to the first terminal 48a of the transition dipole 48 and the other of the conductive plates of the capacitor is therefore linked to the second terminal 48b of the transition dipole 48. The capacitance 49 of the transition dipole 48 can for example be designed as an assembly of several discrete capacitive components electrically arranged in series and/or in parallel and having a total electrical capacitance.

The transition dipole 48 is arranged in the secondary electrical path 2S either upstream of the secondary mechanical switch DS2 as illustrated schematically in FIGS. 4A-4C, or downstream of the secondary mechanical switch DS2 as illustrated in FIGS. 5A and 5B.

In the examples illustrated, the transition dipole 48 includes a voltage limiter 50 arranged electrically in parallel with the capacitance 49 in the transition dipole.

It could be envisaged not to have this voltage limiter, in particular for the case where the capacitance can withstand a significant voltage. However, the presence of a voltage limiter 50 arranged electrically in parallel with the capacitance 49 in the transition dipole allows implementing a capacitance that only has to withstand a relatively reduced voltage, for example on the same order as, but greater than, the voltage drop along the parallel circuit 1. Thus, it will be possible to implement a capacitance whose maximum voltage is comprised between 800 volts and 10,000 volts.

In the case of the presence of the voltage limiter 50, the transition dipole 48 thus includes two parallel branches, both inserted electrically in parallel with each other between a first terminal 48a and a second terminal 48b of the transition dipole 48, in the secondary electrical path 2S. The capacitance 49 is in a first branch. The voltage limiter 50 is in a second branch.

In a first example of electrical architecture illustrated in FIG. 5A, a controlled switch DS3 acting as a controlled switch is electrically arranged in parallel with the secondary electrical path 2S. In this example of electrical architecture, the controlled switch DS3 is therefore also electrically in parallel with the main electrical path 2P. The controlled switch DS3 is then interposed in a tertiary electrical path 2T which, in the example, directly links the two terminals 28, 30 of the mechanical cut-off apparatus 10, and which is therefore in parallel with the main electrical path and with the secondary electrical path. It is noted that, if the controlled switch DS3 is in an electrically closed state, it creates, inside the mechanical cut-off apparatus, a bypass, which is here the tertiary electrical path 2T directly linking the two terminals 28, 30, and that short-circuits the capacitance 49 of the transition dipole 48, in the sense that a current circulating in the mechanical cut-off apparatus 10, between the two terminals 28, 30, does not pass through the capacitance 49, but in the bypass, through the controlled switch DS3. Of course, in this architecture, if the controlled switch DS3 is in an electrically closed state and at the same time the secondary mechanical switch DS2 is also in an electrically closed state, a closed loop is then created which links the two terminals of the capacitance 49 and which will cause the discharge of the capacitance.

In the second example of electrical architecture illustrated in FIG. 5B, a controlled switch DS3 acting as a controlled switch is electrically arranged directly in parallel with the capacitance 49, therefore directly in parallel with the transition dipole 48, but by being inserted into the secondary electrical path 2S, between the secondary mechanical switch and a terminal of the mechanical cut-off apparatus. In FIG. 5B, in which the transition dipole 48 is arranged in the secondary electrical path 2S downstream of the secondary mechanical switch DS2, the controlled switch DS3 is therefore interposed in an electrical path which directly links a downstream secondary contact of the secondary mechanical switch DS2 to the downstream terminal 30 of the mechanical cut-off apparatus 10. However, in one variant in which the transition dipole 48 would be arranged in the secondary electrical path 2S upstream of the secondary mechanical switch DS2, as illustrated in FIGS. 4A-4C, the controlled switch DS3 would therefore be interposed in an electrical path directly linking an upstream secondary contact of the secondary mechanical switch DS2 to the upstream terminal 30 of the mechanical cut-off apparatus 10. In this second example of electrical architecture, if the controlled switch DS3 is in an electrically closed state, it creates, inside the mechanical cut-off apparatus, a bypass, which here consists directly of the controlled switch DS3, and which short-circuits the capacitance 49 of the transition dipole 48, in the sense that a current circulating in the mechanical cut-off apparatus 10, between the two terminals 28, 30, does not pass through the capacitance 49, but in the bypass, through the controlled switch DS3. In this architecture, if the controlled switch DS3 is in an electrically closed state, a closed loop is then created which links the two terminals of the capacitance 49 and which will cause the discharge of the capacitance, regardless of the state of the secondary mechanical switch DS2.

In both embodiments, and whether the transition dipole 48 is arranged upstream or downstream of the secondary mechanical switch, when the controlled switch DS3 is in a closed state, it creates, inside the mechanical cut-off apparatus, a bypass which short-circuits the capacitance 49 of the transition dipole 48, in the sense that a current circulating in the mechanical cut-off apparatus 10, between the two terminals 28, 30, does not pass through the capacitance 49. It is further noted that, in the electrical architecture of FIG. 5A, and whether the transition dipole 48 is arranged upstream or downstream of the secondary mechanical switch DS2, when the controlled switch DS3 is in a closed state, it forms a short circuit in the entire secondary electrical path 2S between the two terminals 28, 30 of the mechanical cut-off apparatus 10, by also short-circuiting the secondary mechanical switch DS2, in this sense that a current circuiting in the mechanical cut-off apparatus 10, between the two terminals 28, 30, does not pass through the secondary mechanical switch DS2 either.

In the embodiment of FIG. 5B, with the controlled switch DS3 inserted into the secondary electrical path 2S between the secondary mechanical switch DS2 and a terminal of the mechanical cut-off apparatus 10, it could be provided to use an electronic switch as a controlled switch. In such a case, the mechanical cut-off apparatus 10 will generally include an electronic control circuit to control the switch DS3. A power supply of the control circuit and/or of the electronic controlled switch will be provided.

However, in the two electrical architectures of FIGS. 5A and 5B, and whether the transition dipole 48 is arranged upstream or downstream of the secondary mechanical switch DS2, it could advantageously be provided that the controlled switch DS3 is designed as a mechanical switch. This is what is represented in particular in FIGS. 4A-4C, where it is seen that the controlled switch is a tertiary mechanical switch DS3 having a pair of tertiary contacts 60, 62 which are movable relative to each other between at least one open position corresponding to a mechanically open state of the tertiary mechanical switch (FIGS. 4A and 4C), and at least one closed position corresponding to a mechanically and electrically closed state (FIG. 4B) of the tertiary mechanical switch DS3. Given the considered voltages across the pair of tertiary contacts 60, 62, the open position also corresponds to an electrically open state of the tertiary mechanical switch.

In the two electrical architectures of FIGS. 5A and 5B, and whether the transition dipole 48 is arranged upstream or downstream of the secondary mechanical switch DS2, the transition dipole 48 and the secondary electrical path 2S are devoid of a dedicated inductive component. The secondary electrical path 2S may have, like any circuit, a parasitic inductance, resulting in particular from the very nature of the electrical components it comprises, and resulting from the geometry of the circuit. However, within the meaning of the invention, this secondary electrical path 2S and the transition dipole 48 do not include any dedicated inductive component, that is to say any discrete component having a desired inductive function, therefore any component having an inductance greater than a parasitic inductance, in particular any coil or any inductive ferromagnetic core. The transition dipole 48 thus has a very low equivalent inductance, for example less than 50 microhenrys, preferably less than 10 microhenrys, more preferably less than 1 microhenry.

In the exemplary embodiment of FIGS. 4A-4C, the first electrode 20 includes a tertiary contact 60 which is intended to be in contact with the movable connection member 24 when the mechanical cut-off apparatus is in an intermediate closing state, for example that illustrated in FIG. 4C, and, in this example, more particularly with a tertiary contact 62 of the movable connection member 24, designed as a tubular contact. On the contrary, when the connection member 24 has reached an opening position, as illustrated in FIG. 4A, the electrical contact between the tertiary contact 62 of the movable connection member 24 and the tertiary contact 60 of the first electrode 20 is broken.

In the example, the tertiary contactor 60 of the first electrode 20 is fixed and extends along a tubular geometry of axis A1, so as to delimit an open inner bore along the axis A1. It can be designed as several conductive contact blades, which extend each in a radial plane containing the axis A1, distributed about the axis A1 following the tubular geometry, and all including a free contact end at the same radial distance from the axis A1. In the example, the tertiary contactor 60 of the first electrode 20 extends coaxially around the secondary contact 39 which is carried by the same electrode 20.

The tertiary contact 62 of the second electrode 22, here carried by the movable connection member 24 and permanently electrically linked to the movable connection member, is configured, for all the positions of the range of relative intermediate positions of the electrodes for which the tertiary electrical path is closed, to be engaged in the inner bore of the contact 60 of the first electrode 20, by ensuring electrical contact between the two tertiary contacts 60, 62. One of these positions is illustrated in FIG. 4B. In the example, the tertiary contact 62 of the second electrode is designed as a tube of axis A1 carried at the free end of the movable member 24. This tube extends coaxially around the contact rod which forms the secondary contact 38. In the electrically closed position of the tertiary mechanical switch DS3, the free contact end of each of the conductive contact blades forming the tertiary contact 60 bears on an outer surface of the tertiary contact 62 in the form of a tube. On the contrary, beyond the electrical opening position of the tertiary mechanical switch DS3, the contact between the two tertiary contacts 60, 62 is lost. The movable connection member 24 therefore forms, with the body of the first electrode, at the level of the pair of tertiary contacts 60, 62, a tertiary mechanical switch DS3.

When the mechanical cut-off apparatus 10 includes a controlled switch DS3 which, in an electrically closed state, creates inside the mechanical cut-off apparatus a bypass that short- circuits the capacitance 49, and which is designed as a tertiary mechanical switch, the apparatus also includes a mechanical control of the tertiary mechanical switch DS3 which ensures the relative displacement of the tertiary contacts between the open and closed positions of the tertiary mechanical switch DS3. In the example of FIGS. 4A-4C, each of the two electrodes 20, 22 carries one of the tertiary contacts 60, 62, so that the mechanical control of the tertiary mechanical switch DS3 is in fact the same as the mechanical control of the main mechanical switch DS1, namely the one that ensures the displacement of the movable member 24 relative to the first electrode 20.

For the case where the mechanical cut-off apparatus includes a controlled switch which, in an electrically closed state, creates inside the mechanical cut-off apparatus a bypass that short-circuits the capacitance 49, and which is designed as an electronic tertiary switch, the control of the tertiary switch is an electronic control, which generally implements an electronic monitoring unit.

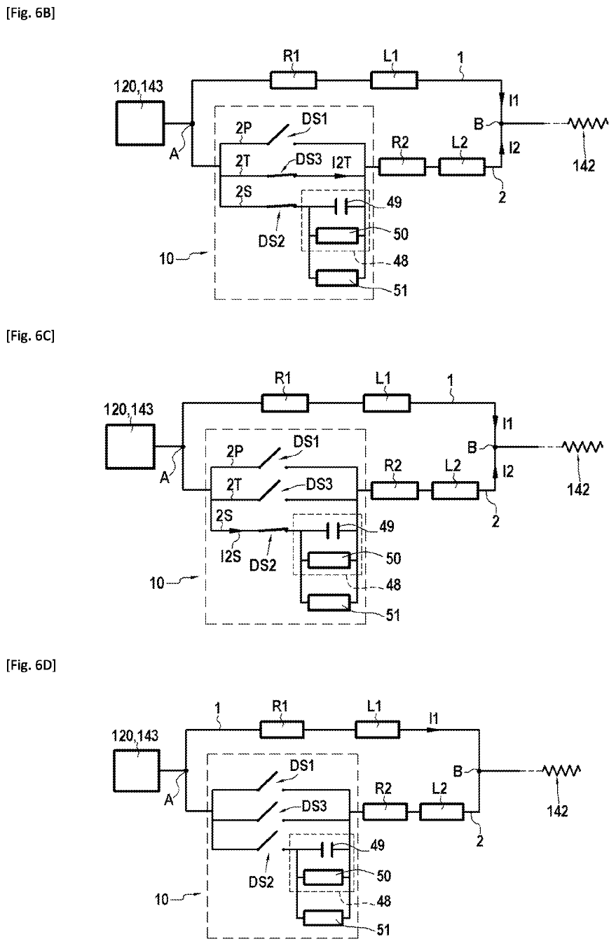

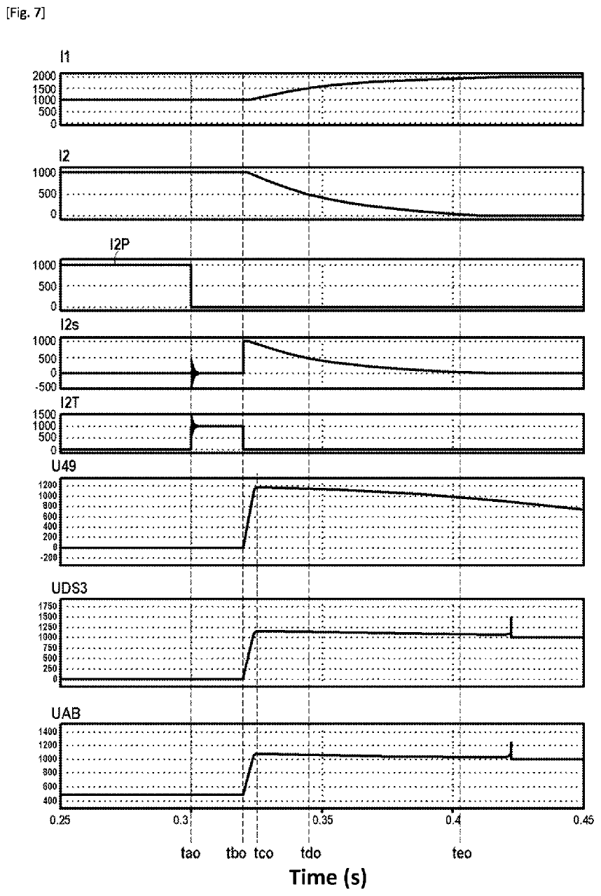

Advantageously, as will be seen later, the mechanical cut-off apparatus is configured such that, in an opening operation of the mechanical cut-off apparatus 10, the controlled switch DS3 is brought into an electrically open state after the main mechanical switch DS1 has been brought into its mechanically open state, but before the secondary mechanical switch DS2 is brought into its mechanically open state, which is illustrated by the sequence of FIGS. 6A-6D, and also by the sequence of FIGS. 13A-13D. In the embodiments where the controlled switch DS3, which creates inside the mechanical cut-off apparatus a bypass that short-circuits the capacitance 49, is designed as a tertiary mechanical switch, the control of the main DS1, secondary DS2 and tertiary DS3 mechanical switches is therefore advantageously configured such that, in an opening operation of the mechanical cut-off apparatus 10, the tertiary mechanical switch DS3 is brought into its open state after the main mechanical switch DS1 has been brought into its mechanically open state and before the secondary mechanical switch DS2 is brought into its mechanically open state.

It will be seen that this sequencing allows ensuring the electrical opening of the mechanical cut-off apparatus by minimizing the appearance of an electric arc and by ensuring that the electric arc is extinguished when the mechanically open state of the mechanical cut-off apparatus is reached, to ensure electrical opening of the circuit.

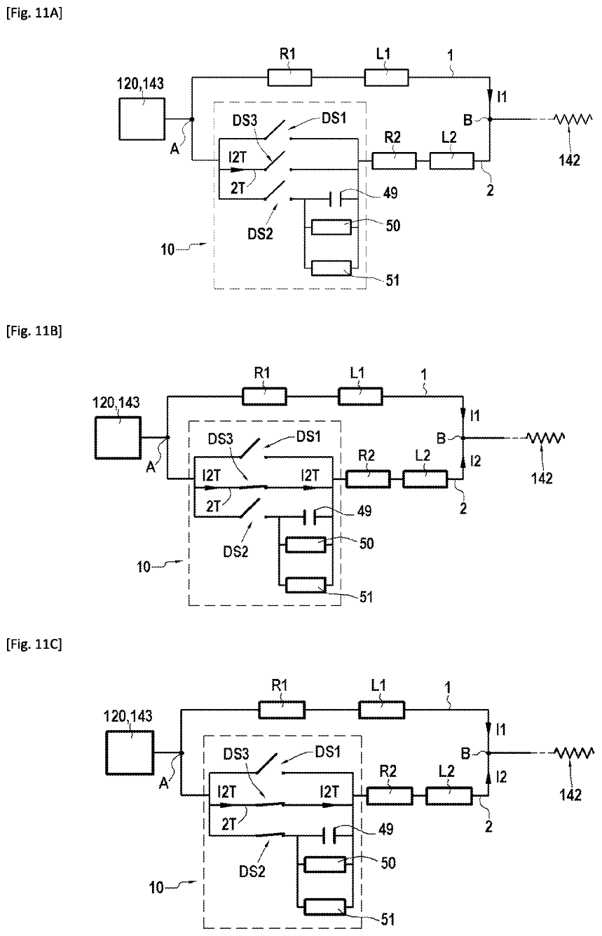

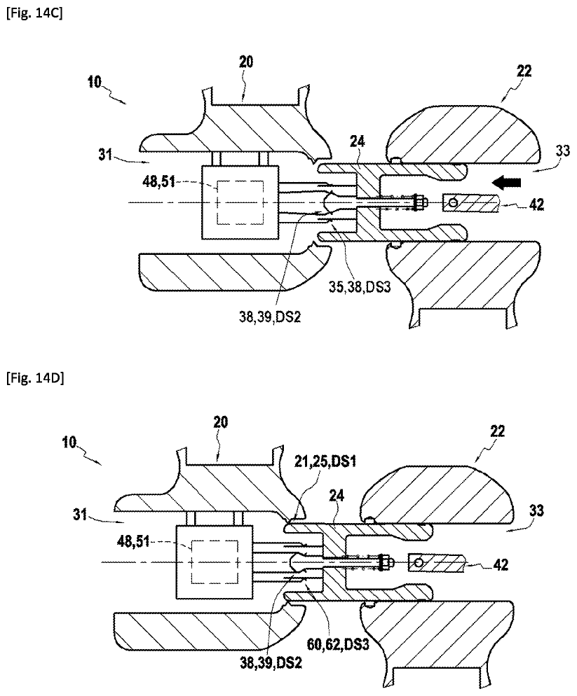

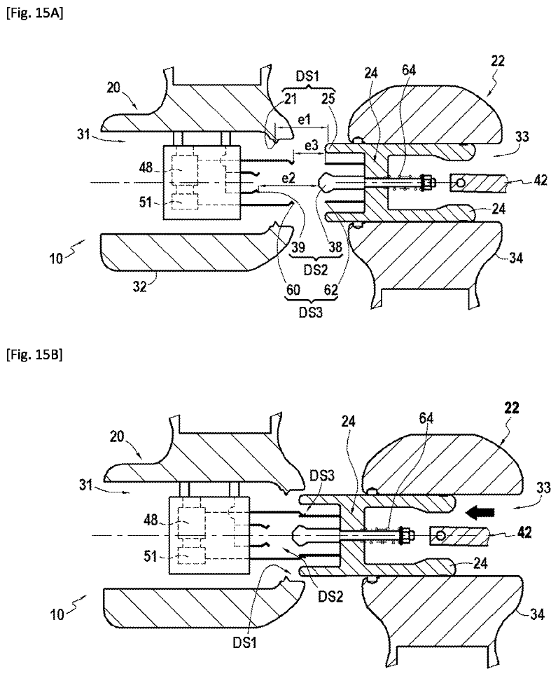

On the other hand, the mechanical cut-off apparatus 10 is configured such that, in a closing operation of the mechanical cut-off apparatus 10, the main mechanical switch DS1 and the secondary mechanical switch DS2 are brought into their mechanically closed state after the controlled switch DS3 has been brought into its electrically closed state, which is illustrated by the sequence of FIGS. 11A-11D, and also by the sequence of FIGS. 14A-14D. In the embodiments where the controlled switch DS3, which creates inside the mechanical cut-off apparatus a bypass that short-circuits the capacitance 49, is designed as a tertiary mechanical switch, the control of the main DS1, secondary DS2 and tertiary DS3 mechanical switches is therefore advantageously configured such that, in a closing operation of the mechanical cut-off apparatus 10, the main mechanical switch DS1 and the secondary mechanical switch DS2 are brought into their mechanically and electrically closed state after the tertiary mechanical switch DS3 has been brought into its mechanically and electrically closed state.

It could be provided that for each of the main mechanical switch DS1, of the secondary mechanical switch DS2 and of the controlled switch DS3 is provided with its own independent control to move from its mechanically open state to its mechanically and electrically closed state, and vice versa, independently. The controls can then be operated following a sequence to obtain the desired sequencing. It could also provided that, among the main mechanical switch DS1, the secondary mechanical switch DS2 and the controlled switch DS3, two of them are provided with a common control, and that the last one is provided with an independent control.

However, it is advantageous to provide a single control for both the main mechanical switch DS1, the secondary mechanical switch DS2 and the controlled switch DS3. In this case, the passage of the mechanical cut-off apparatus from the opening configuration to the closing configuration, and vice versa, is advantageously monitored by a passive mechanism that does not require independent control.

In the mechanical architecture illustrated in FIGS. 4A-4C, 13A-13D, 14A-14D, this dual property can be implemented as follows. It is observed that, on each of the two electrodes 20, 22, more specifically on the first electrode 20 and on the movable member 24 with regard to the embodiment represented, the main contact and the tertiary contact of the same electrode have a fixed position on the considered electrode. In addition, for a given relative position of the two electrodes in their opening or closing movement, the main contact pair and the tertiary contact pair have a relative spacing between the contacts of the pair, respectively “e1” and “e3”, that is different, which is illustrated in FIG. 4A. This is apparent in a position where the two main DS1 and tertiary DS3 mechanical switches, are in a mechanically open state. It is seen that the relative spacing “e1” between the main contacts 21, 25 which form the main mechanical switch DS1, is greater than the relative spacing “e3” between the tertiary contacts 60, 62 which form the tertiary mechanical switch DS3. Thus, for an intermediate position or a range of intermediate positions of the electrodes between the electrical opening position and the complete electrical closing position, the main electrical path 2P is interrupted at the level of the pair of main contacts 21, 25 while an electrical path is closed at the level of the pair of tertiary contacts 60, 62, thus allowing the passage of an electric current, which is illustrated more particularly in FIG. 13B for an opening movement and in FIG. 14C for the closing movement. In such a position, the tertiary mechanical switch DS3 creates, inside the mechanical cut-off apparatus, a bypass that short-circuits the capacitance 49 of the transition dipole 48.

On the other hand, in the example illustrated, one at least of the contacts of the pair of secondary contacts 38, 39 is movable on the electrode 20, 22, 24 which carries it, between an opening configuration adopted during the opening movement and a closing configuration adopted during the closing movement of the electrodes, in a closing operation of the mechanical cut-off apparatus 10. These opening and closing configurations correspond to a different relative spacing “e2” between the two contacts of the pair of secondary contacts 38, 39 for the same given relative position of the two electrodes, such that:

during the opening movement, the pair of secondary contacts separates after the pairs of main and tertiary contacts;

during the closing movement, the pair of secondary contacts comes into contact after the pair of tertiary contacts.

Preferably, during the closing movement, the pair of main contacts and the pair of secondary contacts come into contact after the pair of tertiary contacts.

In practice, in the illustrated embodiment, the secondary contact 38 of the second electrode 22 is movable on the electrode which carries it, in this case movable on the movable connection member 24, between two distinct positions along the axis A1 relative to the movable connection member 24 which carries it, one position corresponding to the opening configuration and the other to the closing configuration. In the closing configuration position, the secondary contact 38 is retracted along the axis A1 relative to the movable connection member 24 to increase its spacing “e2” relative to the secondary contact 39 carried by the other electrode 20. In the opening configuration position, the secondary contact 38 is advanced along the axis A1 relative to the movable connection member 24 to reduce its spacing relative to the secondary contact 39 carried by the other electrode. It could be provided that it is the secondary contact 39 of the first electrode 20 that is movable on the electrode which carries it, or that the two secondary contacts 38, 39 of the first and second electrodes 20 are both movable each on the electrode which carries it. In the example, the contact rod 38 which forms the secondary contact is therefore movably mounted in translation along the axis A1 on the movable connection member 24. It is for example guided in translation along the axis A1 in a bore of the movable connection member 24.

In the example, the passage of the secondary contact from the opening configuration is controlled passively. Indeed, in the example, the secondary contact 38 is elastically returned to that of its positions which corresponds to one of the opening or closing configurations. In the example, the secondary contact 38 is elastically returned to its position which corresponds to the closing configuration. The elastic return is for example ensured by a return spring 64.

In the example, it is by mechanical cooperation with a member of the mechanical cut-off apparatus, here with the other secondary contact 39, that the secondary contact 38 is brought into its other position corresponding to the other of the open or closed configurations. In the example, it was seen that the secondary contact 38 is engaged in the inner bore of the contactor 39 of the first electrode 20, to ensure electrical contact between the two secondary contacts. In the example, the secondary contact 38 and the contactor 39 of the first electrode 20, are provided with complementary shapes which create a first peak of mechanical strength which prevents the loss of contact between the two below a threshold force in the direction of the opening. This first peak of mechanical strength is greater than the elastic return force, exerted in the example by the return spring 64, so that, before allowing the opening of the secondary mechanical switch DS2, the spacing movement of the electrodes, in the opening direction, causes the passage of the secondary contact 38 from its closing configuration to its opening configuration. In other words, from a certain position, the movement of the electrodes causes the displacement of the secondary contact relative to the movable connection member 24 which carries it, from the closing configuration to the opening configuration. When the secondary contact 38 reaches its opening configuration, it abuts in its relative movement relative to the electrode which carries it. It is noted that, for this position illustrated in FIG. 4C and in FIG. 13C, the tertiary switch DS3 is already in a mechanically open state. This abutment causes the separation force, exerted on the secondary contact 38 by the movable connection member 24 which carries it, to exceed the first peak of mechanical strength and cause the separation of the two contacts 38, 39. In the example, as soon as the separation of the two secondary contacts 38, 39 is acquired, the elastic return brings the secondary contact 38 into its position which corresponds to the closing configuration.

Other mechanisms could be provided to allow the passage of the mechanical cut-off apparatus 10 from its opening configuration to its closing configuration, including mechanisms comprising an actuator specific to the change of configuration. It is moreover noted that, in the example, the system is monostable, with only one stable configuration which is the closing configuration. However, a bistable system could be provided with a system which is elastically forced either into the opening configuration or into the closing configuration, and a control device which switches the system from one to the other, for example depending on the direction of movement of the electrodes.

In the invention, the voltage limiter can be or can comprise a surge protector 50, or voltage surge arester, and is a device which limits the voltage peaks across its terminals, and therefore in particular which limits the voltage peaks across the capacitance 49. The voltage limiter can be designed as an assembly of several discrete components electrically arranged in series and/or in parallel. Preferably, the assembly of several discrete components electrically arranged in series and/or in parallel has, from the point of view of the rest of the device, the behavior of a single surge protector having an equivalent transition voltage for the assembly and a protection voltage for the assembly. A surge protector generally comprises an electrical component which has a variable resistance as a function of the electrical voltage across its terminals. The variation of the resistance value is generally not linear with the electrical voltage across the surge protector. Generally, below a transition voltage across the surge protector, the resistance of the latter is high, with no or relatively small decrease in its resistance as a function of the increase in voltage, and the surge protector let pass only a leakage current, preferably less than 1 ampere (A), or less than 100 milliamperes (mA), or even less than or equal to 1 milliampere (mA). On the contrary, above the transition voltage across the surge protector, the resistance of the latter rapidly decreases as a function of the voltage increase, which reaches a peak clipping voltage value, or protection voltage, for which the resistance of the surge protector becomes low or even very low. In other words, the surge protector acts as a voltage limiter across its terminals over the current interval for which it has been chosen. It opposes the protection voltage when passing the highest current for which the surge protector has been dimensioned. Below the transition voltage, it tends to prevent the passage of the current. Beyond the transition voltage, it authorizes the passage of the current through the surge protector for a small increase in the voltage across its terminals. As known, the transition voltage is generally not a precise value but rather corresponds to a transition voltage range. However, in the present text, as a definition, the transition voltage of a surge protector will be the voltage for which the surge protector lets a current of 1 ampere (A) to pass therethrough. The protection voltage is the voltage across the surge protector when it is traversed by the highest current for which it has been dimensioned. Among the surge protectors, the surge arresters are known in particular, which may in particular comprise the varistors and the “TVS” (Transient Voltage Suppressor) diodes, such as the “Transil™” diodes. In particular, within the framework of the invention, a surge protector can comprise a metal oxide varistor (or MOV). The voltage limiter may be or may comprise a spark gap.

In the examples illustrated, a circuit for discharging the capacitance 49 of the transition dipole 48 is provided. In the examples illustrated, the discharge circuit is a passive discharge circuit, with no active component. In this example, the discharge circuit includes a resistance 51 which is arranged electrically in parallel with the transition dipole 48, therefore in parallel with the capacitance 49 of the transition dipole 48, and therefore in parallel with the voltage limiter 50 of the transition dipole 48 Preferably, the resistance 51 has a high electrical resistance value R51, for example comprised between 10 ohms and 1,000 ohms, more particularly between 50 ohms and 300 ohms, such that the dipole, which consists of the capacitance 49 of the transition dipole 48 and the resistance 51 arranged in parallel, has a significant time constant relative to an electrical cut-off period in the secondary mechanical switch DS2, for example a time constant greater than 100 milliseconds (ms), preferably greater than 500 milliseconds (ms). Conversely, this time constant must be sufficiently reduced so that the capacitance 49 is discharged in a relatively short time, so that the system is able to be operational again after a first implementation. Therefore, it will be advantageously provided that the time constant is less than 3 seconds, preferably less than or equal to 1 second. In this example, the time constant can be considered as being equal to the product R51×C49. Another type of discharge circuit, not illustrated in the drawings, could include a controlled switch. Thus, a discharge circuit could comprise a controlled switch which would be directly electrically arranged in series with the resistance 51, all of these two components being in parallel with the transition dipole 48. When the controlled switch would be switched in a closed state letting the current pass, a discharge circuit would be formed between the two plates of the capacitance 49 of the transition dipole 48. Preferably, the controlled switch would be a mechanical switch which would be similar to the main mechanical switch DS1 and to the secondary mechanical switch DS2, that is to say comprising a pair of contacts, one of which would be carried by one of the electrodes and the other by the other of the electrodes so as to open and close electrically in such a way temporally coordinated with that of the main mechanical switch DS1 and the secondary mechanical switch DS2 in particular. It can be considered that the circuit for discharging the capacitance 49 of the transition dipole 48 is integrated into the transition dipole 48, by forming a third parallel branch of this transition dipole 48.

In the examples illustrated, it is seen that each electrode 20, 22 has a conductive outer peripheral surface 32, 34 having an essentially convex geometry and devoid of protruding portions and, inside the casing defined by its conductive outer peripheral surface 32, 34, each electrode 20, 22 has an inner cavity 31, 33. The electrical transition dipole 48 can be advantageously housed inside the casing determined by the conductive peripheral surface 32, 34 of one of the two electrodes 20, 22, preferably by being entirely received inside said inner cavity 31, 33. However, it could also be provided that all or part of the electrical transition dipole 48 are arranged outside the casing defined by the conductive outer peripheral surface 32, 34 of the electrode 20, 22, while preferably remaining arranged inside the internal volume 16 of the mechanical cut-off apparatus.

In all cases, when the controlled switch DS3 is designed as a mechanical switch, a mechanical cut-off apparatus is obtained, the electrically open state of which can be observed visually, by visualizing the separation of the tertiary contacts, in addition to the separation of the main and secondary contacts.

It will now be described, with reference to FIGS. 6A to 6D, to FIGS. 7 to 10, and to FIGS. 13A-13D, the operation of one embodiment of a mechanical cut-off apparatus 10 according to the invention by describing the main steps of an opening operation of such a mechanical cut-off apparatus. More specifically, the case of a mechanical cut-off apparatus having the electrical architecture illustrated in FIG. 5A will be considered here. However, what is described below concerning the opening operation of a mechanical cut-off apparatus is equally valid for the case of a mechanical cut-off apparatus having the electrical architecture illustrated in FIG. 5B. In the description below, it is considered that the mechanical cut-off apparatus 10 is, as illustrated in FIG. 2, integrated into a second electric circuit 2 arranged in parallel with a first electric circuit 1. The two electric circuits 1, 2 may have by way of example the same equivalent electrical resistance, respectively R1 and R2, and the same equivalent electrical inductance L1 and L2 respectively, but this is only a special case.

FIG. 7 illustrates, for the passage of the mechanical cut-off apparatus from an electrically closed state, to an electrically open state, the variations over time of:

the intensity I1 in the first electric circuit 1;

the intensity I2 in the second electric circuit 2;

the intensity I2P of the electric current in the main electrical path 2P, therefore through the main mechanical switch DS1;

the intensity I2S of the electric current in the secondary electrical path 2S, therefore through the secondary mechanical switch DS2;

the intensity I2T of the electric current through the tertiary mechanical switch DS3;

the voltage U49 across the capacitance 49;

the voltage UDS3 across the controlled switch DS3;

the voltage UAB between the junction points A and B of the two parallel circuits 1 and 2.

The values indicated correspond to the following situation:

Current source delivering a nominal current of 2,000 A;

Voltage across the open mechanical cut-off apparatus 10: 1,000 V, corresponding to the voltage UAB across the two parallel circuits 1 and 2 when circuit 1 is closed and traversed by the nominal current, therefore corresponding to the voltage drop in the parallel circuit 1 under this nominal current;

capacitance value C49 of the capacitance 49: 4 millifarad;

resistance value R51 of the discharge resistance 51: 50 ohm.

In an initial state, it is considered that all the mechanical cut-off apparatuses 10 in the two circuits 1, 2 are in a complete electrical closing state, letting a current respectively I1 and I2 pass in each circuit. In the case envisaged above in which the two circuits have the same equivalent resistance and the same equivalent inductance, the initial values of the currents I1 and I2 are equal, for example equal to 1,000 A.

In this initial state, it is considered that all of the current I2 passing through the mechanical cut-off apparatus 10 circulates along the main electrical path 2P, in which therefore an electric current I2P is equal to the electric current I2 circulating in the second electric circuit 2. For this, the current which is likely to circulate, in this embodiment, in the tertiary electrical path 2T and which may present parasitic resistances and inductances, is neglected. Furthermore, the secondary electrical path 2S includes, in series, the transition dipole 48 which means that the impedance of the secondary electrical path 2S is higher, by several orders of magnitude, than that of the main electrical path 2P, so that it can be considered that no current passes in the secondary electrical path 2S. This initial state is represented in FIGS. 6A and 13A.

The opening operation of the mechanical cut-off apparatus 10 begins with a step of opening the main electrical path 2P within the mechanical cut-off apparatus 10, by spacing of the main contacts 21, 25 of the main mechanical switch DS1. This step begins at an instant “tao” illustrated in FIG. 7. The secondary mechanical switch DS2 and the controlled switch which is here designed as the tertiary switch DS3 both remain electrically closed.

In the case of a mechanical cut-off apparatus as shown in FIGS. 4A-4C, this corresponds to a control of the movable member 24 according to its opening movement from its complete electrical closing position, in the direction of its electrical opening position. The instant “tao” corresponds to the moment of last contact of the main contacts 21, 25. Just after the instant “tao”, we are therefore in the state illustrated in FIGS. 6B and 13B. As a result, the electric current through the mechanical cut-off apparatus 10 switches almost instantaneously from the main electrical path 2P to the tertiary electrical path 2T.

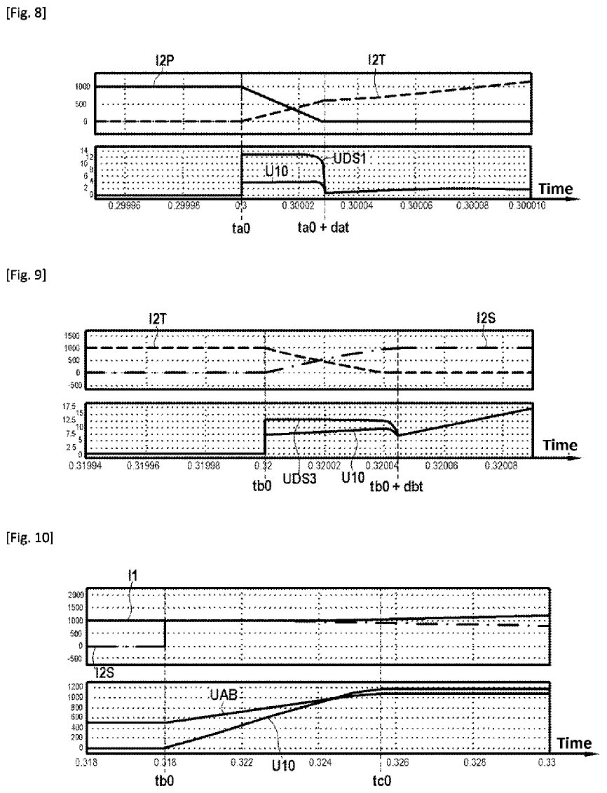

This switching is illustrated in FIG. 7, and in FIG. 8 which represents, with a time scale expanded relative to FIG. 7, the variation on the one hand of the currents I2P and I2T in the main electrical path 2P and in the tertiary electrical path 2T, and on the other hand the voltage UDS1 across the main mechanical switch DS1. The tertiary electrical path 2T in which the tertiary mechanical switch DS3 is located has a lower impedance compared to that of the secondary electrical path 2S. It is noted that the intensity I2P of the current through the main mechanical switch DS1 drops extremely quickly to a zero value, in an extremely low switching duration “dat”, for example by less than a tenth of a millisecond in the example illustrated, which is apparent in particular from FIG. 8. It is noted in this FIG. 8 the appearance of a peak of the voltage UDS1 across the the main mechanical switch DS1 which is extremely limited in value, because on the order of ten volts, and which is extremely short in duration since its duration corresponds to the switching duration “dat”. If an electric arc settles between the main contacts 21, 25 of the main mechanical switch DS1, its arc voltage and its duration will therefore be extremely low, resulting in minimal wear of the main contacts 21, 25. In FIG. 8, it is noted that, during this very short switching duration “dat”, the voltage UDS1 across the main mechanical switch DS1 becomes greater than the voltage U10 across the mechanical cut-off apparatus 10, which allows the switching of the current from the main electrical path 2P to the tertiary electrical path 2T. it is also noted that the intensity of the current in the secondary electrical path and the intensity of the current in the tertiary electrical path can have an oscillatory phenomenon, which can be explained by the presence of parasitic inductances, but whose amplitude does not modify the operation of the system and which fades in a stabilization duration on the order of a millisecond. Beyond this stabilization duration, it can be considered that all of the current through the mechanical cut-off apparatus 10 circulates in the tertiary electrical path 2T, therefore through the controlled switch which is here designed as the tertiary switch DS3.

At an instant “tbo” following the instant “tao”, the opening operation of the mechanical cut-off apparatus 10 continues by the opening the controlled switch which is here designed as the tertiary switch DS3. The main mechanical switch DS1 remains electrically open, and the secondary mechanical switch DS2 remains electrically closed. In the case of a mechanical cut-off apparatus as shown in FIGS. 4A-4C, this corresponds to a continuation of the control of the movable member 24 along its opening movement in the direction of its electrical opening position. The instant “tbo” corresponds to the moment of last contact of the tertiary contacts 60, 62. Just after the instant “tbo”, we are therefore in the state illustrated in FIGS. 4C, 6C and 13C. As a result, the electric current through the mechanical cut-off apparatus 10 switches almost instantaneously from the tertiary electrical path 2T to the secondary electrical path 2S. This switching is illustrated more particularly in FIG. 9 which represents, with an expanded time scale relative to FIG. 7, the variation on the one hand of the currents I2T and I2S in the tertiary electrical path 2T and in the secondary path 2S, and on the other hand the voltage UDS3 across the tertiary switch DS3. It is noted that the intensity I2T of the current through the tertiary switch DS3 drops extremely quickly to a zero value, in an extremely low switching duration “dbt”, for example by less than a tenth of a millisecond in the example illustrated, which is apparent in particular from FIG. 9. The switching duration “dbt” is determined in particular by the value of the capacitance and the value of possible parasitic inductances. It is noted in this FIG. 9 the appearance of a peak of the voltage UDS3 across the tertiary switch DS3 which is extremely limited in value, because on the order of ten Volts, and which is extremely short in duration since its duration corresponds to the switching duration “dbt”. If an electric arc settles between the tertiary contacts, its arc voltage and its duration will therefore be extremely low, resulting in minimal wear of the tertiary contacts. In FIG. 9, it is noted that, during this very short switching duration “dbt”, the voltage UDS3 across the tertiary switch DS3 becomes greater than the voltage U10 across the mechanical cut-off apparatus 10, which allows the switching of the current from the tertiary electrical path 2T to the secondary electrical path 2S. By switching in the secondary electrical path, the electric current will therefore supply the transition dipole 48. It will be noted that, in the presence of a discharge circuit 51, the capacitance 49 will preferably have been discharged before the start of the opening operation, in any case preferably discharged before the instant of opening of the controlled switch DS3. As the capacitance 49 is charged, the voltage U49 across its terminals increases. This voltage is applied to the terminals of DS3 (by neglecting the voltage drops in the parasitic elements). A capacitance 49 of greater value leads to a slower increase in the voltage across the controlled switch DS3 and therefore to lower voltage stresses on the controlled switch DS3 and on the main mechanical switch DS1. Indeed, with a capacitance of greater value, the characteristic time constant of the charging circuit, consisting of the secondary electrical path 2S and the tertiary electrical path 2T, increases, which leads to a longer charging duration and therefore a slower rise in the voltage at the level of the controlled switch DS3. Consequently, for the same separation distance of the tertiary contacts forming the controlled switch DS3, these will be subjected to a lower voltage stress.

When the voltage U49 across the capacitance 49 exceeds the transition voltage value of the voltage limiter 50, which substantially corresponds to the instant denoted “tco” in FIG. 7, the electrical resistance of the latter drops rapidly and the current which passes through the voltage limiter 50 then increases rapidly. From this instant, the current I2 in the parallel circuit 2 is essentially directed through the voltage limiter 52 which then actively plays its role of limiting the voltage, by limiting the voltage U49 across the capacitance 49 and dissipating energy (in particular magnetic energy accumulated in the parallel circuit 2). During this step, the capacitance 49 and the voltage limiter 50, electrically in parallel, together create a voltage U48 across the transition dipole 48 which tends to oppose the passage of the current in the parallel circuit 2. This voltage is then greater than the voltage drop in the parallel circuit 1, so that the current I2 in the parallel circuit 2 decreases and the current I1 in the parallel circuit 1 increases.

The last step of the opening operation of the mechanical cut-off apparatus 10 consists in the opening of the secondary contacts 38, 39 of the secondary mechanical switch DS2 of the mechanical cut-off apparatus 10, at an instant “tdo” subsequent to the instants “tbo” and “tco”. Between the opening of the controlled switch, here designed as the tertiary mechanical switch DS3, and the opening of the secondary mechanical switch DS2, the current which circulates in the parallel circuit 2 drops due to the opposition of the voltage generated by the capacitance 49 of the transition dipole 48. During the opening of the secondary mechanical switch DS2, the current I2S through the secondary mechanical switch DS2 has become lower than the initial current, for example, less than 80%, preferably less than 60% of the initial current. In one example, it has been chosen to cause the opening of the secondary mechanical switch DS2 when the current I2S through the secondary mechanical switch DS2 has fallen to a value on the order of 600 amperes compared to an initial current of 1,000 A. A higher protection voltage of the voltage limiter 50, or a longer duration [tbo; tdo] between the opening of the tertiary mechanical switch DS3 and the opening of the secondary mechanical switch DS2, allows reducing the intensity of the current which must be cut by DS2, that is to say reducing the current that passes through the secondary mechanical switch DS2 upon its opening by separation of the secondary contacts 38, 39. If an arc is created between the secondary contacts at that time, it will have a lower arc voltage and a much shorter duration than what would be observed without the invention. For the example considered here, the calculations allow determining that, under the conditions described above, this arc would have the passage of an arc current of 580 amperes for a duration less than or equal to 60 milliseconds: This results in an amount of energy of about 110 joules. This amount of energy can be easily evacuated by the secondary contacts 38, 39 of the secondary mechanical switch DS2, recalling that it is, already according to the prior art, specially provided to absorb the arc energy at opening.

The current through the transition dipole 48 is completely canceled at an instant “teo” after a duration following the opening “tbo” of the controlled switch DS3 which, in the example, with the values indicated, is for example a few tens of milliseconds, easily less than 100 milliseconds, for example around 80 milliseconds. From the instant “teo”, it can be considered that the electric current is then entirely transferred to the first circuit 1. In the case of an entirely mechanical mechanical cut-off apparatus, it is possible to modify the mechanical structure of the apparatus in order to extend the time gap between the opening of the tertiary mechanical switch DS3 and the opening of the secondary mechanical switch DS2, so as to wait for the complete cancellation of the current through the capacitance 49 before proceeding with the opening of the contacts of the secondary mechanical switch DS2. This will reduce the wear on the contacts and increase the lifespan of the mechanical cut-off apparatus 10.

The capacitance 49 is then discharged through the discharge circuit, here designed as a discharge resistance 51 which is in parallel with the capacitance 49. The duration of this discharge depends directly on the value C49 of the capacitance 49 and resistance value R51 of the resistance 51. As a first approximation, it can be considered that we are dealing with the discharge of the capacitance 49 in the discharge resistance 51, therefore with a time constant equal to C49×R51. It can be considered that the capacitance is discharged at the end of a duration equal to 3 times the time constant or 5 times the time constant. The components will be advantageously chosen to have a discharge duration comprised between 1 and 10 seconds. In the example, the discharge duration is 3 s. At the end of this discharge duration, the voltage U49 across the capacitance 49 therefore becomes zero.

The opening operation of the mechanical cut-off apparatus 10 can be carried out with a speed of separation of the electrodes 20, 22, 24, and therefore of the contacts carried by these electrodes, which is for example comprised between 0.01 and 5 meters per second.

In general, the presence of the capacitance 49 modifies the impedance of the secondary electrical path 2S. The greater the capacitance value C49 of the capacitance 49, the more the impedance of the secondary electrical path 2S decreases and therefore the more the chances of successful switching increase since the switching from DS3 to DS2 is facilitated during the opening. On the other hand, a capacitance of a higher value and with reasonable dimensions may be difficult to find. Without the capacitance according to the invention, a conventional disconnector cannot carry out a line switching operation according to the desired performance because the arcing voltage created at the opening of the contacts is not sufficient to exceed/oppose the voltage of the parallel line. The addition of the capacitance thus allows circumventing this limitation. Indeed, at opening of DS3, the capacitance is charged and a voltage is thus created across its terminals. When this voltage exceeds the voltage UAB across the parallel circuit 1, it makes the switching from the circuit 2 to the parallel circuit 1 possible.

In general, the role of the voltage limiter 50 is to limit the voltage across the capacitance 49. The value of the protection voltage of the voltage limiter 50 thus determines the maximum value of the voltage across the transition dipole 48, therefore across the capacitance 49. By choosing a protection voltage of the voltage limiter of a greater value, the maximum voltage across the capacitance 49 and therefore the voltage U10 across the cut-off device 10 increase, so that the current switches more quickly from the second circuit 2 to the first parallel circuit 1 and the switching is then more likely to succeed. With the same duration between the opening of the tertiary mechanical switch DS3 and the opening of the secondary mechanical switch DS2, a greater protection voltage of the voltage limiter 50 leads the secondary mechanical switch DS2 to cut off a lower current. On the other hand, this increases the stresses on the capacitance 49 since it will in this case have to withstand a higher voltage across its terminals.

The capacitance 49 is chosen such that its capacitance value C49 allows a successful current switching from the tertiary electrical path 2T to the secondary electrical path 2S. Indeed, in order to allow the switching of current from the tertiary electrical path 2T to the secondary electrical path 2S, a necessary condition is to be able to create in the tertiary electrical path 2T a voltage greater than that in the secondary electrical path 2S.

At opening of the controlled switch DS3, the current I2S in the secondary electrical path 2S, solution of the differential equation which governs the branch, must exceed the value of the current I2 to be switched. This current I2S being in oscillatory mode, we will only be interested in its maximum amplitude. This results in the condition given by the following inequalition:

C49×w′o×(R3p×I2×Uarc)×exp[−PI/(2×w′o×T)]−I2>0

where:
T=2×Lp/Rp, with Rp=R2p+R3p, and R3p and R2p representing the parasitic resistances respectively on the secondary electrical path 2S and the tertiary electrical path 2T;
wo²=1/(Lp×C49), with Lp=L2p+L3p, and L3p and L2p representing the parasitic inductances resulting from the components and the connections between the elements of the circuit respectively on the secondary electrical path 2S and the tertiary electrical path 2T;

w′o²=wo²−(1/T²);

Uarc is the arc voltage across the controlled switch DS3 during its opening.

The condition above is taken from solving the following differential equation, which governs the variation of the current I2S in the secondary circuit as a function of the current I2 to be interrupted:

$$\frac{{d}^{2} Q}{{dt}^{2}} + \frac{2}{T} . \frac{dQ}{dt} + w {o}^{2} Q = ( \frac{R 3 p}{Lp} I 2 + \frac{{U}_{arc}}{Lp} )$$

with Q=∫I2S dt, which therefore represents the charge accumulated in the capacitance 49.

In practice, this leads to capacitance values which are comprised between 1 millifarad and 10 millifarads, more preferably between 3 and 5 millifarads.

For example, for the following values:
R3p=0.5 milli-Ohm;
R2p=0.1 milli-Ohm;
L3p=0.2 microHenrys;
L2p=0.2 microHenrys;
Uarc=13 Volts and
I2=1,000 Amperes
   a minimum theoretical value of the capacitance 49 which is equal to C49=2.36 mF is obtained. In a practical design, this minimum theoretical value of the capacitance 49 could be increased by the effect of a safety multiplying factor, for example equal to 1.1, 1.2, 1.3, etc. Thus, for a minimum theoretical value of 2.36 millifarads, it is possible to choose to use a capacitance 49 having a capacitance value C39 equal to at least 3 millifarads. On the other hand, there will be no interest in using an excessively high safety multiplying factor, so as not to unnecessarily increase the cost and size of the capacitance 49. Thus, for a minimum theoretical value of 2.36 millifarads, it is possible to choose to use a capacitance 49 having a capacitance value C39 equal at most to 5 millifarads.

Experimentally or by numerical simulation, it is for example possible to determine the value of the capacitance adapted to a given device starting from a low value in the ranges above, for example 1 millifarad, and by checking the success of the electrical cut-off in the mechanical cut-off apparatus 10. If the cut-off is not successful, the value of the capacitance is increased, for example by 0.5 millifarad and a new experiment or numerical simulation is carried out.

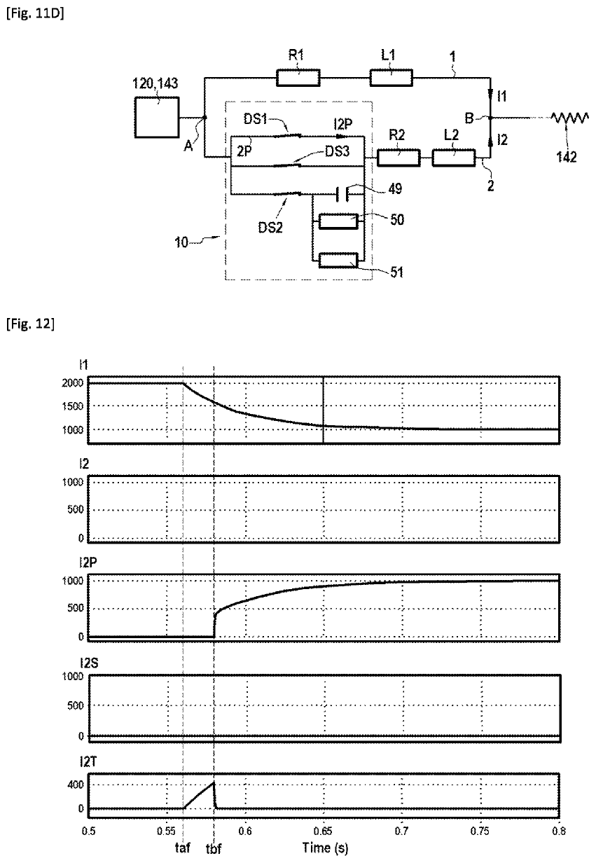

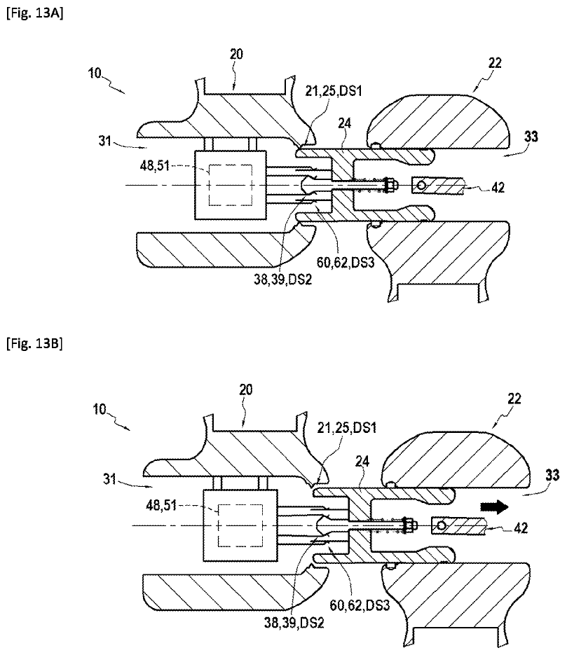

It will now be described, with reference to FIGS. 11A to 11D, to FIG. 12, and to FIGS. 14A-14D, the operation of the same embodiment of a mechanical cut-off apparatus 10 by describing the main steps of a closing operation of such an apparatus, the apparatus being, as illustrated in FIG. 2, integrated into the second electric circuit 2 arranged in parallel with the first electric circuit 1.

In an initial state, for a closing operation, it is considered that an electric current respectively I1, having for example an intensity of 2,000 A, circulates in the first parallel circuit 1, and that the mechanical cut-off apparatus 10 in the second parallel circuit 2 is in an open state so that no electric current circulates in this second parallel circuit 2. In terms of numerical values, we remain in the particular case envisaged above in which the two circuits have the same equivalent resistance and the same equivalent inductance, but the operation would be similar if this were not the case. In this initial state, it is considered that no current passes through the mechanical cut-off apparatus 10. This initial state is represented in FIGS. 4A, 11A and 14A. In this initial state, the mechanical cut-off apparatus 10, which is arranged in the second parallel circuit 2 and which in an open state is subjected between its terminals 28, 30 at a voltage UAB which is equal to the voltage drop in the first parallel circuit 1, between the points A and B of junctions of two parallel circuits 1 and 2, and which therefore depends on the electric current respectively I1 which circulates in the first parallel circuit 1, and on the equivalent resistance or even on the equivalent inductance of the first parallel circuit 1.

The closing operation of the mechanical cut-off apparatus 10 begins with the closing of the controlled switch DS3. In the cases where this controlled switch is designed as a tertiary mechanical switch DS3, for example as described above, the tertiary contacts 60, 62 get closer to each other at a certain speed, which can for example be comprised between 0.01 and 5 meters per second. Initially, no electric arc is present between the tertiary contacts 60, 62.

During the closing movement, it is ensured that the secondary mechanical switch DS2 is in a closing configuration such that the main mechanical switch DS1 and the secondary mechanical switch DS2 are brought to their mechanically closed state after the controlled switch DS3 has been brought to its electrically closed state. Thus, during a closing operation of the apparatus, the operation of restoring the current in the high-voltage electric circuit, the secondary electrical path 2S and the main electrical path 28, 30 are electrically closed after the closing of the tertiary electrical path 2T. This is reflected for example in the fact that, in the examplary embodiment as illustrated espacially in FIG. 4A, the spacing “e3” between the tertiary contacts 60, 62 which form the tertiary mechanical switch DS3 is less tha the relative spacing “el” between the main contacts 21, 25 which form the main mechanical switch DS1, and less than the relative spacing “e2” between the secondary contacts 38, 39 which form the secondary mechanical switch DS2.

In the embodiment of FIGS. 11A and 14A, which uses the electrical architecture illustrated in FIG. 5A, in which the controlled switch DS3 is in parallel with the secondary electrical path 2S, an electric arc can be formed between the tertiary contacts of the controlled switch DS3 when these tertiary contacts 60, 62 are sufficiently close to each other. Indeed, in this embodiment, the controlled switch DS3 is then subjected to the voltage UAB which is equal to the voltage drop in the first parallel circuit 1. However, the arc between the tertiary contacts 60, 62 of the controlled switch DS3 disappears rapidly during the final closing of the tertiary contacts, illustrated by the instant “taf” in FIG. 12. Once this contact has been established through the controlled switch DS3 in its closed state, part of the current then switches gradually from the first parallel circuit 1 to the second parallel circuit 2, by circulating through the controlled switch DS3. In the embodiment of FIGS. 11B and 14B, this electric current therefore circulates in the tertiary path. This restoration of the current in the second parallel circuit 2 takes place without passing through the secondary electrical path 2S, therefore without passing through the transition dipole 48, therefore without passing through the capacitance 49 nor the voltage limiter 50.

Still within the framework of one embodiment using the electrical architecture illustrated in FIG. 5A, in which the controlled switch DS3 is in parallel with the secondary electrical path 2S, and in parallel with the main mechanical switch DS1, the closing operation of the mechanical cut-off apparatus 10 can continue either by the closing of the secondary mechanical switch DS2, followed by that of the main mechanical switch DS1 or, conversely, by the closing of the main mechanical switch DS1, followed by that of the secondary mechanical switch DS2.

With the mechanical architecture of the embodiment illustrated in FIGS. 4A to 4C, the closing operation of the mechanical cut-off apparatus 10 continues with the closing of the secondary mechanical switch DS2, which is illustrated in FIGS. 11C and 14C, followed by that of the main mechanical switch DS1, which is illustrated in FIGS. 11D and 14D, in that order.

Indeed, in all cases using the electrical architecture illustrated in FIG. 5A, once the controlled switch DS3 is closed, the closing of the secondary mechanical switch DS2 and/or of the main mechanical switch DS1 takes place under a very low voltage, which can be considered negligible, across the concerned mechanical switch, this voltage being the one imposed by the prior closing of the controlled switch DS3.

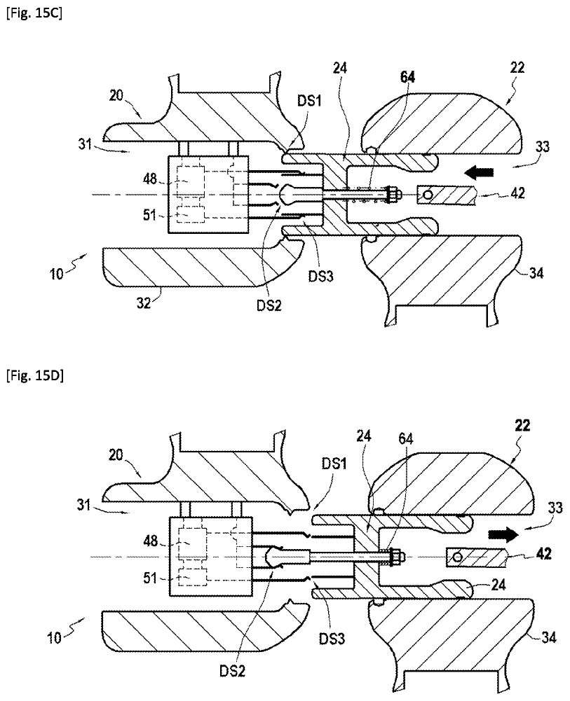

However, for the closing, in the cases using the electrical architecture illustrated in FIG. 5A, it may be preferred to use a mechanical architecture as illustrated in FIGS. 15A to 15D, which implements, for the closing operation of of the mechanical cut-off apparatus 10, after the closing of the controlled switch DS3, the closing of the main mechanical switch DS1, followed by that of the secondary mechanical switch DS2.

This embodiment is very close to the one previously described in relation to FIGS. 4A-4C.

We find the characteristic according to which, on each of the two electrodes 20, 22, the main contact 21, 25 and the tertiary contact 60, 62 of the same electrode have a fixed position on the considered electrode. In addition, for a given relative position of the two electrodes 20, 22 in their opening or closing movement, the main contact pair 21, 25 and the tertiary contact pair 60, 62 have a relative spacing, respectively “e1” and “e3” between the contacts of the pair that is different, which is illustrated in FIG. 15A. This is apparent in a position where the two main DS1 and tertiary DS3 mechanical switches are in a mechanically open state. It is seen that the relative spacing “e1” between the main contacts 21, 25 which form the main mechanical switch DS1, is greater than the relative spacing “e3” between the tertiary contacts 60, 62 which form the tertiary mechanical switch DS3. Thus, for an intermediate position or a range of intermediate positions of the electrodes between the electrical opening position and the complete electrical closing position, the main electrical path 2P is interrupted at the level of the pair of main contacts 21, 25 while a tertiary electrical path 2T is closed at the level of the pair of tertiary contacts 60, 62, thus allowing the passage of an electric current, which is illustrated more particularly in FIG. 15B. In such a position, the tertiary mechanical switch DS3 creates, inside the mechanical cut-off apparatus, a bypass that short-circuits the capacitance 49 of the transition dipole 48.

As in the example of FIGS. 4A-4C, one at least of the contacts of the pair of secondary contacts 38, 39 is movable on the electrode 20, 22, 24 which carries it, between an opening configuration adopted during of the opening movement and a closing configuration adopted during the closing movement of the electrodes, in a closing operation of the mechanical cut-off apparatus 10. These opening and closing configurations correspond to a different relative spacing “e2” between the two contacts of the pair of secondary contacts 38, 39 for the same given relative position of the two electrodes 20, 22, 24, such that:

during the opening movement, the pair of secondary contacts 38, 39 separates after the pairs of main 21, 25 and tertiary 60, 62 contacts;
during the closing movement, the pair of secondary contacts 38, 39 comes into contact with each other after the pair of tertiary contacts 60, 62.

The secondary contact 38 of the second electrode is also movable on the electrode which carries it, between an opening configuration of the mechanical cut-off apparatus 10 which is adopted during the opening movement (FIG. 15D) and a closing configuration of the mechanical cut-off apparatus 10 which is adopted during the closing movement (FIGS. 15A-15C). In this example, it is therefore still the secondary mechanical switch DS2 that has two different configurations relative to the electrodes to modify the configuration of the mechanical cut-off apparatus 10. These two configurations of the secondary mechanical switch DS2, and consequently of the mechanical cut-off apparatus 10, allow obtaining on the one hand a first contact of the two secondary contacts 38, 39 during the closing, and on the other hand a last contact of the two secondary contacts 38, 39 during the opening, which correspond to different relative positions of two electrodes 20, 22, 24, more particularly, in this embodiment, to different relative positions of the movable connection member 24 relative to the first electrode 20.

The difference between the two embodiments lies in the fact that the first contact position of the two secondary contacts 38, 39 during the closing corresponds to an even closer relative position of two electrodes, more particularly, in this embodiment, to a closer relative position of the movable connection member 24 relative to the first electrode 20, than the one prevailing for the embodiment of FIGS. 4A to 4C. This is permitted by the different geometry of the secondary contact 39, which is offset axially relative to the embodiment of FIGS. 4A to 4C. In the example of FIGS. 15A to 15D, in the closing configuration of the electrodes, the spacing “e1” between the two main contacts 21, 25 is smaller than the spacing “e2” between the two secondary contacts 38, 39, so that, in a closing operation, the closing of the main mechanical switch DS1 is obtained before that of the secondary mechanical switch DS2. On the contrary, during an opening operation, the secondary mechanical switch DS2 reaches an opening configuration illustrated in FIG. 15D in which the secondary mechanical switch DS2 opens after the main mechanical switch DS1, and after that of the controlled switch DS3. This is permitted by the fact that the secondary contact 38 of the second electrode 22 is movable on the electrode which carries it, in this case movable on the movable connection member 24, between two distinct positions along the axis A1 relative to the movable connection member 24 which carries it, one position corresponding to the opening configuration and the other to the closing configuration. These two distinct positions, visible for one in FIGS. 15A-15C and for the other in FIG. 15D, has a larger spacing than what was provided in the embodiment of FIGS. 4A-4C. The contact rod 38 which forms the secondary contact is therefore movably mounted in translation along the axis A1 on the movable connection member 24 following a greater travel than what was provided for the embodiment of FIGS. 4A-4C.

It is noted that this embodiment follows the same opening sequence as that of FIGS. 4A-4C, so that what has been described above concerning the opening of the cut-off device 10 remains valid in this embodiment, with the same operating mode as the one described above.

Within the framework of the electrical architecture illustrated in FIG. 5B, in which the controlled switch DS3 is inserted into the secondary electrical path 2S between the secondary mechanical switch DS2 and a terminal of the mechanical cut-off apparatus 10, the closing operation of the mechanical cut-off apparatus preferably takes place in the following order: closing of the controlled switch DS3, followed by that of the secondary mechanical switch DS2, followed by that of the main mechanical switch DS1. It is recalled that, in this architecture, the controlled switch DS3 can be an electronic switch or a mechanical switch. The closing of the controlled switch DS3 preferably takes place without voltage across the controlled switch DS3. Indeed, it takes place while the secondary mechanical switch DS2 is still open, and it will preferably have been ensured, in particular thanks to the discharge circuit, formed in the example by the discharge resistance 51, that the capacitance 49 is discharged before the start of the closing operation, or before the closing of the controlled switch DS3. Within the framework of the architecture of FIG. 5B, the closing of the controlled switch DS3 does not modify the current circulation in the first parallel circuit 1, the second parallel circuit 2 remaining open. Also, during the closing of the secondary mechanical switch DS2, an electric arc can be formed between the secondary contacts of the controlled switch DS2 when these secondary contacts are sufficiently close to each other. Indeed, in this embodiment, the secondary mechanical switch DS2 is, upon its closing, subjected to the voltage UAB which is equal to the voltage drop in the first parallel circuit 1. However, the arc between the secondary contacts of the secondary mechanical switch DS2 rapidly disappears during the final closing of the contacts. Once this contact has been established through the secondary mechanical switch DS2 in its closed state, part of the current then switches gradually, from the first parallel circuit 1 to the second parallel circuit 2, by then circulating through the secondary mechanical switch DS2, therefore in the secondary path 2S. This restoration of the current in the second parallel circuit 2 through the secondary path 2S however takes place without passing through the transition dipole 48, therefore without passing through the capacitance 49 nor through the voltage limiter 50, because the transition dipole 48 is short-circuited by the controlled switch DS3.

The invention is not limited to the described and represented examples because various amendments can be made thereto without departing from its framework.

1.-24. (canceled)

25. A mechanical cut-off apparatus of a high-voltage electric circuit, the mechanical cut-off apparatus including:
an upstream terminal and a downstream terminal which are intended to be electrically linked respectively to an upstream portion and a downstream portion of the electric circuit;
in a main electrical path between the upstream and downstream terminals of the mechanical cut-off apparatus, a main mechanical switch having a pair of main contacts which are movable relative to each other between at least one open position corresponding to a mechanically open state of the main mechanical switch, and at least one closed position corresponding to a mechanically and electrically closed state of the main mechanical switch in which the main contacts establish a nominal electrical connection of the mechanical cut-off apparatus, the nominal electrical connection allowing the passage of a nominal electric current through the mechanical cut-off apparatus;
in a secondary electrical path which is electrically in parallel with the main mechanical switch between the upstream and downstream terminals of the mechanical cut-off apparatus, a secondary mechanical switch, having a pair of secondary contacts which are movable relative to each other between at least one open position, corresponding to a mechanically open state of the secondary mechanical switch, and at least one closed position corresponding to a mechanically and electrically closed state of the secondary mechanical switch;
a mechanical control of the main mechanical switch and of the secondary mechanical switch configured such that, in an electrical opening operation of the mechanical cut-off apparatus, the secondary mechanical switch is brought to its mechanically open state after the main mechanical switch has been brought to its mechanically open state;
wherein the apparatus includes a transition dipole comprising a capacitance, the transition dipole being electrically arranged in series with the pair of secondary electrical contacts in the secondary electrical path, and in that the apparatus includes a controlled switch which, in an electrically closed state, creates inside the mechanical cut-off apparatus a bypass that short-circuits the capacitance of the transition dipole.

26. The mechanical cut-off apparatus according to claim 25, wherein the discharge circuit includes a discharge resistance which is arranged electrically in parallel with the capacitance and electrically in parallel with the voltage limiter of the transition dipole.

27. The mechanical cut-off apparatus according to claim 25, wherein the controlled switch is electrically arranged in parallel with the transition dipole, in the secondary electrical path, between the secondary mechanical switch and a terminal of the mechanical cut-off apparatus.

28. The mechanical cut-off apparatus according to claim 27, wherein the controlled switch is a tertiary mechanical switch having a pair of tertiary contacts which are movable relative to each other between an open position corresponding to a mechanically open state of the tertiary mechanical switch, and a closed position corresponding to a mechanically and electrically closed state of the tertiary mechanical switch.

29. The mechanical cut-off apparatus according to claim 27, wherein the controlled switch is an electronic switch.

30. The mechanical cut-off apparatus according to claim 26, wherein the controlled switch is electrically arranged in parallel with the secondary electrical path, and in that the controlled switch is a tertiary mechanical switch having a pair of tertiary contacts which are movable relative to each other between at least one open position corresponding to a mechanically open state of the tertiary mechanical switch, and at least one closed position corresponding to a mechanically and electrically closed state of the tertiary mechanical switch.

31. The mechanical cut-off apparatus according to claim 25, wherein the mechanical cut-off apparatus is configured such that:
in an opening operation of the mechanical cut-off apparatus, the controlled switch is brought into an electrically open state after the main mechanical switch has been brought into its mechanically open state and before the secondary mechanical switch is brought into its mechanically open state;
in an electrical closing operation of the mechanical cut-off apparatus, the main mechanical switch and the secondary mechanical switch are brought into their mechanically and electrically closed state after the controlled switch has been brought into an electrically closed state.

32. The mechanical cut-off apparatus according to claim 28, wherein the mechanical cut-off apparatus includes a mechanical control of the tertiary mechanical switch, and in that the mechanical control of the main, secondary and tertiary switches is configured such that:
in an opening operation of the mechanical cut-off apparatus, the tertiary mechanical switch is brought into its mechanically open state after the main mechanical switch has been brought into its mechanically open state and before the secondary mechanical switch is brought into its mechanically open state;
in a closing operation of the mechanical cut-off apparatus, the main mechanical switch and the secondary mechanical switch are brought into their mechanically and electrically closed state after the controlled switch formed as a tertiary mechanical switch has been brought into its mechanically and electrically closed state.

33. The mechanical cut-off apparatus according to claim 25, wherein, in a closing operation of the mechanical cut-off apparatus, the secondary mechanical switch is brought into its mechanically and electrically closed state after the main mechanical switch has been brought to its electrically and mechanically closed state.

34. The mechanical cut-off apparatus according to claim 25, wherein, in a closing operation of the mechanical cut-off apparatus, the secondary mechanical switch is brought into its mechanically and electrically closed state before the main mechanical switch has been brought into its electrically and mechanically closed state.

35. The mechanical cut-off apparatus according to claim 32, wherein it includes two electrodes:
which are electrically linked respectively to the upstream terminal and to the downstream terminal of the mechanical cut-off apparatus,
which each carry one of the contacts of the pairs of main, secondary and tertiary contacts,
and which are movable relative to each other along a relative opening movement and a relative closing movement, between at least one electrical opening position corresponding to an electrically open state of the mechanical cut-off apparatus and a complete electrical closing position corresponding to an electrically closed state of the mechanical cut-off apparatus in which the electrodes establish, through the pair of main contacts, the nominal electrical connection of the mechanical cut-off apparatus;
wherein, on each of the two electrodes, the main contact and the tertiary contact have a fixed position on the considered electrode;
in that, for a given relative position of the two electrodes in their opening or closing movement, the main contact pair and the tertiary contact pair have a relative spacing between the contacts of the pair that is different, so that, in an opening operation of the mechanical cut-off apparatus to bring it from its closed state to its open state, for an intermediate position or a range of intermediate positions of the electrodes between the electrical opening position and the complete electrical closing position, the main electrical path is interrupted at the level of the pair of main contacts while an electrical path remains closed at the level of the pair of tertiary contacts;
and in that one at least of the contacts of the pair of secondary contacts is movable on the electrode which carries it, between an opening configuration adopted during the opening movement and a closing configuration adopted during the closing movement, the opening and closing configurations corresponding to a different relative spacing between the two contacts of the pair of secondary contacts for the same given relative position of the two electrodes, such that:
during the opening movement, the pair of secondary contacts separates after the pairs of main and tertiary contacts;
during the closing movement, the pair of secondary contacts comes into contact after the pair of tertiary contacts.

36. The mechanical cut-off apparatus according to claim 35, wherein the relative closing and opening movements of the electrodes and the relative closing and opening movements between the two contacts of the pairs of main and tertiary contacts are the same and are translational movements, and in that the two configurations of the pairs of secondary contacts correspond to two different relative positions of the two secondary contacts along the direction of translation for the same relative position of the electrodes.

37. The mechanical cut-off apparatus according to claim 25, wherein the capacitance is chosen such that its capacitance value C49 fulfills the condition given by the following inequation:
C49×w′o×(R3p×I2+Uarc)×exp[−PI/(2×w′o×T)]−I2>0 where:
T=2×Lp/Rp, with Rp=R2p+R3p, and R3p and R2p representing the parasitic resistances respectively on the secondary electrical path 2S and the tertiary electrical path;
wo²=1/(Lp×C49), with Lp=L2p+L3p, and L3p and L2p representing the parasitic inductances resulting from the components and the connections between the elements of the circuit respectively on the secondary electrical path 2S and the tertiary electrical path;
w′o²=wo²−(1/T²);
Uarc is the arc voltage across the controlled switch DS3 during its opening.

38. The mechanical cut-off apparatus according to claim 25, wherein the capacitance is comprised between 1 millifarad and 10 millifarads, more preferably between 3 and 5 millifarads.

39. An electrical installation including at least one mechanical cut-off apparatus according to claim 25.

40. An electrical installation, wherein it includes a first electric circuit between a first point and a second point, a second electric circuit, electrically in parallel with the first electric circuit between the first point and the second point, and a mechanical cut-off apparatus according to claim 25 in at least one of the circuits for cutting off the electric current in the circuit.

41. A method comprising an operation of cutting off a high-voltage electric circuit and then an operation of restoring the current in the high-voltage electric circuit, implementing a mechanical cut-off apparatus having an upstream terminal and a downstream terminal which are intended to be electrically linked respectively to an upstream portion and a downstream portion of the electric circuit, in which, for the operation of cutting off the high-voltage electric circuit, an opening operation of the mechanical cut-off apparatus is carried out, in which:
a main electrical path, between the upstream and downstream terminals of the mechanical cut-off apparatus, which allows the passage of a nominal electric current, is mechanically and electrically opened to switch the current in a secondary electrical path which is electrically in parallel with the main electrical path between the upstream and downstream terminals of the mechanical cut-off apparatus so as to charge a capacitance inserted in the secondary electrical path;
after expiry of a period following the opening of the main electrical path, the secondary electrical path is mechanically and electrically opened,
wherein, during the opening of the main electrical path, the electric current is first switched in a bypass, which is electrically in parallel with the main electrical path between the upstream and downstream terminals of the mechanical cut-off apparatus and that short-circuits the capacitance, before switching it to the secondary electrical path comprising the capacitance,
and in that, for the operation of restoring the current in the electric circuit, the secondary electric path and the main electric path are electrically closed after the closing of the bypass that short-circuits the capacitance.

42. The method according to claim 41, wherein the voltage across the capacitance is limited by the presence of a voltage limiter electrically in parallel with the capacitance in the secondary electrical path.

43. The method according to claim 42, wherein the bypass is created by a controlled switch acting as a controlled switch which is interposed in a tertiary electrical path which directly links the two terminals of the mechanical cut-off apparatus, and which is parallel to the main electrical path and to the secondary electrical path.

44. The method according to claim 41, wherein the bypass is created by a controlled switch acting as a controlled switch which is electrically arranged directly in parallel with the capacitance by being inserted into the secondary electrical path, between the secondary mechanical switch and a terminal of the mechanical cut-off apparatus.
